(19) United States
(12) Patent Application Publication
(10) Pub. No.: US 2020/0189332 A1
(43) Pub. Date: Jun. 18, 2020

(54) TYRE PUMP

(71) Applicant: EDWARD JOHN O'CONNOR, Kilburn, London (GB)

(72) Inventor: Edward John O'CONNOR, London (GB)

(21) Appl. No.: 16/638,886

(22) PCT Filed: Aug. 13, 2018
(86) PCT No.: PCT/GB2018/052297

§ 371 Date: Feb. 13, 2020

(30) Foreign Application Priority Data
Aug. 14, 2017 (GB) 1713039.4
Mar. 28, 2018 (GB) 1805063.3

(51) Int. Cl. B60C 23/12

(52) U.S. Cl. CPC B60C 23/12; B60C 19/00

(57) ABSTRACT

A pump for use on the inside surface of the tread of a tyre, the pump comprising: a base plate for attaching to the inside surface of the tread of a tyre; a compression plate; a first restraint connected to the base plate and arranged to engage a first side of the compression plate; a second restraint connected to the base plate and arranged to engage a second side of the compression plate; and a compressible chamber arranged between the compression plate and the base plate; wherein the compressible chamber comprises an inlet and an outlet and is arranged to contain a fluid; wherein the pump is arranged such that when the pump is attached to the inside surface of the tread of a rolling tyre, the first and second restraints move the compression plate relative to the base plate as the pump traverses a contact patch of the tyre such that the compressible chamber is peristaltically compressed between the compression plate and the base plate, ejecting fluid from the compressible chamber through the outlet and then drawing fluid in to the compressible chamber through the inlet.

### FIELD

The present disclosure relates to a pump suitable for inflating a tyre, in particular, a peristaltic pump for attaching to the inside of the tread of a tyre.

### BACKGROUND

Pneumatic tyres are widely used on domestic, commercial and industrial vehicles as they provide significant benefits in terms of ride comfort and vehicle performance. Such tyres typically have an optimal pressure, optimal pressures, or an optimal pressure range, at which they perform best.

Given the nature of pneumatic tyres and the environments in which they are used, there is often the need to input air into the tyre to keep the tyre at its optimal pressure. This may be in response to the gradual leakage of air over time, or to a deliberate reduction in the tyre pressure. Pumping up pneumatic tyres which are already at an elevated pressure can be time consuming, often requires specialist equipment and, in some cases, can be dangerous. It would therefore be desirable to provide a device for pumping up tyres which alleviates some of the above problems.

In order to interrupt the use of a tyre in order to pump it up, it has previously been suggested to locate pumps permanently inside the tyre to operate automatically as the tyre is in use. Suggested systems which locate a pump inside the tyre of a wheel and automatically inflate the tyre using the motion or deformation of the tyre typically encounter a number of issues. Systems which are built into the tyre at the manufacturing stage prevent previously manufactured tyres from utilising this device and increase manufacturing cost and complexity. It also means that any faults with the pump system are likely to require the whole tyre, or even wheel, to be replaced.

The quantity or rate of air being input into the tyre by existing systems, or the pressure of air being input into the tyre is often insufficient. Furthermore, such systems are often unable to self-regulate, or require a large electronic regulator which has to be located externally and connected to the pump. This makes such systems prohibitively heavy and unwieldy.

### SUMMARY

The present disclosure provides devices and methods for inflating tyres which overcome the aforementioned disadvantages.

The disclosure provides a pump for use on the inside surface of the tread of a tyre. The tread of the tyre may be the road-contacting surface of the tyre. That is, the pump may be fixable on the inside of the circumferential curved surface of a tyre. The pump may be attachable to the inside surface of the tread of a tyre. The pump may be an in-tyre pump. The pump may be an air pump actuated by deformation of the tyre during rolling.

The pump may be arranged to be automatically actuated using the deformation of the tyre to which it is attached. The deformation may be that caused by the rolling motion of the tyre on a surface. This may allow the pump to automatically inflate the tyre while the tyre is in use, negating the need to interrupt use of the tyre to increase.

When a tyre to which a load is applied (even if that load is simply the weight of the tyre) is rolled along a surface, a contact patch is formed between the tyre and the surface. The contact patch is a flat interface region of the tread surface of the tyre. As the tyre rolls along a surface, the contact patch moves around the circumference of the tyre, causing deformation of the tread surface. This deformation may be used to actuate a pump.

As used herein, deformation may refer to a change in shape caused by interaction with the contact patch. A tyre tread surface which is distal from the contact patch may be undeformed. A base plate attached to a tyre tread surface which is distal from the contact patch (e.g. at the top of the tyre) may be undeformed. When the base plate is adjacent the contact patch the shape of the base plate is being changed due to the contact patch, it may be considered deformed.

According to an example is a pump for use on the inside surface of the tread of a tyre, the pump comprising:
a base plate for attaching to the inside surface of the tread of a tyre; a compression plate;
a first restraint connected to the base plate and arranged to engage a first side of the compression plate;
a second restraint connected to the base plate and arranged to engage a second side of the compression plate; and
a compressible chamber arranged between the compression plate and the base plate; wherein the compressible chamber comprises an inlet and an outlet and is arranged to contain a fluid;
   wherein the pump is arranged such that when the pump is attached to the inside surface of the tread of a rolling tyre, the first and second restraints move the compression plate towards the base plate as the pump traverses a contact patch of the tyre such that the compressible chamber is peristaltically compressed between the compression plate and the base plate, ejecting fluid from the compressible chamber through the outlet and then drawing fluid in to the compressible chamber through the inlet.

According to an example is a pump for use on the inside surface of the tread of a tyre, the pump comprising:
a base plate for attaching to the inside surface of the tread of a tyre; a compression plate;
a first restraint connected to the base plate and arranged to engage a first side of the compression plate;
a second restraint connected to the base plate and arranged to engage a second side of the compression plate; and
a compressible chamber arranged between the compression plate and the base plate; wherein the compressible chamber comprises an inlet and an outlet and is arranged to contain a fluid;
   wherein the pump is arranged such that when the pump is attached to the inside surface of the tread of a rolling tyre, the first and second restraints move the compression plate relative to the base plate as the pump traverses a contact patch of the tyre such that the compressible chamber is peristaltically compressed between the compression plate and the base plate, ejecting fluid from the compressible chamber through the outlet and then drawing fluid in to the compressible chamber through the inlet; the pump further comprising:
a filtration device fluidically connectable to the environment for receiving fluid from the environment;
   wherein the pump is configured to expel fluid through the filtration device to clean the filtration device.

The pump may comprise a base plate. The base plate may be configured to be attached to the inside surface of a tyre. The base plate may be configured to be attached to the inside surface of the tread of a tyre.

The base plate may comprise a connector for fixing the base plate relative to the tyre, e.g. the inside surface of the tread of the tyre. The connector may comprise a male or female connector and may be arranged to engage a male or female connector located on the inside surface of the tyre. The connector may comprise one of an elongated protrusion and an elongated slot arranged to receive the elongated protrusion. The other of the elongated protrusion or elongated slot for receiving the elongated protrusion may be arrangeable on the inside surface of a tyre.

The base plate may comprise a first connector attachable to the inside surface of the tyre by way of a second connector located on the inside surface of the tyre wherein the first and second connectors are arranged to be interlockable or otherwise securely connectable and disconnectable.

The base plate may be substantially planar. The base plate may be arranged such that it is substantially planar and it lies parallel to and adjacent the tread of the tyre. The base plate may therefore be arranged to deform in response to deformation of the road-contacting surface of the tyre. The deformation of the base plate may mimic, or correspond, to that of the tread of the tyre. The base plate may be configured to deform such that the curvature of the base plate increases and decreases during use.

The base plate (as well as the compression plate, compressible chamber, support and housing) may comprise a length which is greater than its depth and height. The length of the base plate may extend in a substantially circumferential direction when attached to a tyre—that is, the base plate (and/or compression plate, compressible chamber, support, housing and pump in general) may be arranged to extend substantially circumferentially around the inside surface of the tread of a tyre.

The pump may comprise a compression plate. The compression plate may be arranged substantially parallel to the base plate and/or tread surface of the tyre. The compression plate may comprise a substantially planar surface. The substantially planar surface may be arranged on a lower side of the compression plate, closest to the base plate.

The compression plate may be rigid or substantially rigid. A lower surface of the compression plate may be rigid or substantially rigid.

The pump may comprise a first restraint connected to the base plate and arranged to engage a first side of the compression plate. The pump may comprise a second restraint connected to the base plate and arranged to engage a second side of the compression plate. The first and second sides may be first and second ends. Each restraint may be connectable and disconnectable to/from both the base plate and the compression plate. Where terms such as connected, fixed or the like are used herein, it is to be understood that the terms may be replaced with connectable, fixable etc.

Each restraint may be permanently connected to the base plate and/or compression plate. Each restraint may be hingedly or pivotally connected to the base plate and/or compression plate. Each restraint may be arranged to engage a side of the compression plate in a selective manner—that is, the restraint may be arranged to engage the compression plate and exert a force on the compression plate when the pump is in a certain arrangement (e.g. deformed), but be disengaged from, or unrestrained relative to, the compression plate when the pump is in an alternative arrangement (e.g. undeformed).

Each restraint may comprise a stretchable section, e.g. an elastic section. Each restraint may comprise a rigid section, e.g. a metal or plastic section. Each restraint may be adjustable in length.

The first and second restraints may be rigid and may be connected to the compression plate. The first and second restraints may be arranged to move the compression plate away from the base plate when the curvature of the base plate increases.

The first restraint and second restraint may be unitary. The first and second restraints may be provided by a single unitary restraint—for example as a single integral part.

The first restraint and second restraint may alternatively be separate. The first and second restraints may be independent restraints, e.g. independent from each other.

The restraints may be arranged to move the compression plate both towards and away from the base plate. The restraints may be arranged to move the compression plate towards the base plate in order to compress the compressible chamber, and away from the base plate to allow the compressible chamber to inflate or expand.

The compression plate may be urged towards the base plate by the first and second restraints. The compression plate may be urged away from the base plate by a resiliently deformable surrounding wall arranged around the compressible chamber.

Alternatively, the compression plate may be urged away from the base plate by rigid restraints attached to the compression plate.

In addition to restraints, the pump may comprise straps for holding the compression plate in place. The straps may not provide any pump functionality, but may simply be structural members to maintain the compression plate, compressible chamber, housing, support and/or base plate in place.
The first restraint may be connected to a first end (e.g. the end of the first side) of the compression plate. The first restraint may be connected to a first anchor point on the base plate.
The second restraint may be connected to a second end (e.g. the end of the second side) of the compression plate. The second restraint may be connected to a second anchor point on the base plate.

Each restraint may be arranged to engage an end of the compression plate. The compression plate may comprise attachment devices which may be connectors or locators, for engaging (either permanently or selectively) the restraints. The attachment devices may be located on either end of the compression plate and may be arranged on flanges which are angled with respect to a planar surface of the compression plate.

The restraints may perform the function of the straps described below, and the restraints. As such, the restraints may be configured to provide pump functionality and secure the pump within a tyre.

The base plate may comprise a plurality of anchor points. An anchor point may act as a connector or attachment device to which a further component may be connected. The base plate may comprise anchor points to which the first and second restraints are connected.

The pump may comprise a compressible chamber. The compressible chamber may be sandwiched between the compression plate and the base plate, either directly or indirectly.

The compressible chamber may be considered a fluid or air chamber, a deformable reservoir or a flexible container.

The compressible chamber may comprise an inlet and an outlet. The inlet may be arranged at the back or at a side of the compressible chamber with respect to the motion of the pump caused by rotation of the tyre. The outlet may be arranged at the front or at a side of the compressible chamber with respect to the motion of the pump caused by rotation of the tyre.

It is to be understood that while the terms inlet and outlet are used to describe respective ends of the compressible chamber, these are not to be interpreted strictly or restrictively. That is, as described herein, fluid may—at times—flow into the compressible chamber via the outlet and may flow out of the compressible chamber via the inlet (for example when air is not input into the tyre and is instead used to clean a filter). The terms inlet and outlet are descriptive of the operation of the respective ends during a normal compression cycle used to inflate the tyre.

The compressible chamber may be arranged to contain a fluid and be configured to eject or evacuate fluid from the chamber through the outlet, and draw fluid in to the chamber through the inlet.

The pump may be configured to protect the compressible chamber from external pressure—e.g. internal tyre pressure. The compressible chamber may be separated/protected from the fluid pressure inside the tyre by the housing e.g. a wall or enclosure or protective cover thereof.

It is to be understood that the term fluid, as used anywhere herein, may be gas. The gas may be air. As such, the term fluid may be replaced with gas, or air, anywhere herein.

The compressible chamber is arranged to be peristaltically compressed between the compression plate and base plate (although not necessarily by the compression plate and base plate directly). The compressible chamber is arranged to be peristaltically compressed as a tyre to which the pump is attached rolls along a surface. As the pump is peristaltically compressed, fluid may be ejected through the outlet and drawn in through the inlet.

The compressible chamber may be attached to the compression plate. The compressible chamber may be attached to the base plate and/or a support. The compressible chamber may be attached to a compression surface (e.g. of the base plate or support). The compressible chamber may be attached over the entire upper and/or lower surface of the compressible chamber. The compressible chamber may be attached over the entire compression surface. The compressible chamber may be separate but attachable to the compression plate and/or base plate. Alternatively, the compressible chamber may be integral with one, or both, of the base plate, support or compression plate.

The pump may be arranged such that, when attached to a rolling tyre and the base plate is deformed due to movement of the pump over the contact patch, the compressible chamber is peristaltically compressed such that the compressible chamber is sequentially compressed by: a first end of the compression plate only; both the first and second ends of the compression plate; and a second end of the compression plate only. The first end may be adjacent the inlet of the compressible chamber. The second end may be adjacent the outlet of the compressible chamber.

Accordingly, according to the disclosure is a method for inflating a tyre, wherein a pump as described anywhere herein is attached to the inside surface of the tread of a rolling tyre, and the method comprises:
urging a first end of the compression plate towards the base plate (for example as the pump approaches the tyre contact patch) such that a first end of the compressible chamber adjacent the compressible chamber inlet is compressed; urging a second end of the compression plate towards the base plate (for example as the pump traverses the tyre contact patch) such that a second end of the compressible chamber adjacent the compressible chamber outlet is compressed, causing fluid to be ejected from the outlet;
urging the first end of the compression plate away from the base plate, such that the first end of the compressible chamber is expanded, causing fluid to be drawn into the compressible chamber inlet; and
urging the second end of the compression plate away from the base plate, such that the second end of the compressible chamber is expanded.

The above may be steps which are undertaken sequentially in the shown order.

The peristaltic compression of the compressible chamber may be facilitated by the restraints sequentially exerting a force on the compression plate towards the base plate. The sequential movement of the restraints may be caused by the deformation of the base plate as it moves over the contact patch of the rolling tyre.

When the pump is not adjacent the contact patch, the tyre—and thus base plate—has a substantially constant curvature. When the base plate has a constant curvature corresponding to that of the tyre, it will be considered undeformed. When the pump is directly above the contact patch, the tyre tread surface—and thus base plate—has been deformed (flattened) by the contact patch. This flattening may act to move the restraints “downwards” i.e.—towards the tyre tread surface. In turn, the restraints may exert a downwards force on the compression plate, moving it towards the base plate thus compressing the compressible chamber. As the pump approaches the contact patch, the restraints are actuated sequentially, causing the peristaltic compression.

The pressure of the tyre may determine the size of the contact patch. The size of the contact patch may determine the amount of deformation experienced by the base plate and, accordingly, the relative movement of the restraints and the compression of the compressible chamber. As such, the pressure in the tyre may determine, or affect, the compression of the compressible chamber—the higher the pressure, the smaller the contact patch, the less compression of the compressible chamber.

The location of the anchor points on the base plate to which the restraints are attached, the length of the restraints and the spacing of the compression plate and the base plate may determine the deformation of the base plate required in order to compress the compressible chamber.

The first and second anchor points and the first and second restraints may be configured such that:
the compressible chamber is compressed when the base plate comprises a substantially flat portion of at least a threshold length.

The compressible chamber may only be compressed between the compression plate and the base plate when the pump traverses a tyre contact patch of a threshold length.

The threshold length may be substantially equal to or greater than the contact patch length for an optimally inflated tyre.

The first and second anchor points and the first and second restraints may be arranged such that the compressible chamber is not compressed when the pump is installed and used in an optimally-, or over-, inflated tyre.

The first and second anchor points and the first and second restraints may be arranged such that the base plate can be deformed as the pump traverses a contact patch without compressing the compressible chamber.

The first and second restraints may be arranged such they are slack when the base plate is attached to a tyre tread surface which is undeformed.

The first and second anchor points and the first and second restraints may be arranged such that the anchor points can move relative to the compression plate without the restraints exerting a force on the compression plate and/or the compression plate being moved towards the base plate and/or the compressible chamber being compressed.

The spacing of the first and second anchor points and the length of the first and second restraints may be selected such that a certain degree of deformation of the base plate is required to compress the compressible chamber. If there is not sufficient deformation of the base plate, the movement of the restraints relative to the compression plate may not be sufficient for the restraints to exert a force on the sides of the compression plate. For example, the restraints may be of a length such that they only become taut when the base plate is deformed by a threshold amount (corresponding to comprising a flat portion of a threshold length).

Accordingly, the base plate may need to comprise a flat portion—corresponding to the contact patch—of at least a threshold length for the compressible chamber to be compressed.

The threshold length may be substantially equal to or greater than the length of a contact patch of an optimally inflated tyre.

If the threshold length is substantially equal to the length of a contact patch of an optimally inflated tyre, the base plate will not be deformed sufficiently to activate the pump when the tyre is over-inflated, but will be deformed sufficiently to activate the pump when the tyre is under-inflated.

The pump may be arranged such that the compressible chamber is only compressed when the pump is installed in an underinflated tyre. The pump may be arranged such that the base plate is only deformed sufficiently to activate the pump and compress the compressible chamber when the tyre is underinflated.

The pump may comprise a housing to house the compressible chamber and/or compression plate. The housing may comprise the surrounding wall.

The housing and/or surrounding wall may comprise a valve configured to allow air into the surrounding wall from the tyre. The valve may be a one-way valve. The housing and/or surrounding wall may be configured to receive air from the tyre or from the pump during inflation. The housing and/or the surrounding wall may be configured to comprise pressurised fluid.

The housing may comprise the protective cover.

The housing, either alone or in combination with any of the other components of the pump, may be configured to be pressure resistant. The pump may be arranged to withstand the pressure within a pneumatic tyre and to operate as described herein in such environments. The pump may therefore comprise a pressure resistant housing or may comprise surrounding walls and seals designed to ensure the pump can operate under pressures typically encountered in pneumatic tyres. The pump may be a sealed unit. The pump may be configured to protect the compressible chamber from air pressure outside of the pump e.g. internal tyre pressure. The pump may be configured such that the compressible chamber can expand to draw in air from the environment while being located on the inside of a tyre. The pump may be configured such that the internal pressure of the pump is maintained at a level in which air from the atmosphere is drawn in to the compressible chamber as the compression plate moves away from the base plate. The pump may be configured such that the air pressure exerted on the outside of the compressible chamber does not exceed atmosphere pressure (e.g. about 0.1 MPa).

The pump may further comprise a surrounding wall arranged around the compressible chamber.

The surrounding wall may be resiliently deformable and may be arranged to bias the compression plate away from the compressible chamber.

The surrounding wall may be responsible for returning the compressible chamber from a compressed state to an expanded state, thus causing the compressible chamber to draw fluid in through the inlet.

The housing and/or surrounding wall may be solid and made from a resilient material, such as rubber. The housing and/or surrounding wall may be hollow and/or comprise pressurised fluid to provide resilience.

The pump may further comprise a support arranged between the base plate and the compressible chamber. The support may comprise curved ribs. The curved ribs may be arranged on a lower side of the support. The base plate may comprise complementary curved ribs. The curved ribs of the support may be arranged to engage the ribs on the base plate. The support may comprise a flat upper surface arranged to support the compressible chamber. The ribs may be guides. The support may be rigid or substantially rigid. The support may comprise a rigid or substantially upper surface—e.g. a compression surface.

The support may be arranged to rock with respect to the base plate. The support may be for supporting the compressible chamber. The support may provide a flat upper surface against which the compressible chamber is compressed.

The support may provide the interface between the flat lower surface of the compressible chamber and the deformable, curved surface of the base plate. In some examples, however, the pump may not comprise a support. Instead, the lower surface of the compressible chamber may be provided with a flexible surface for attachment to, or abutment against, the base plate.

The pump may comprise a compression surface against which the compressible chamber is compressed by the compression plate. The compression surface may be immediately adjacent the compressible chamber. The compression surface may oppose the compression plate. The compression surface may be part of the base plate. The compression surface may be part of the support, where a support is present.

The pump may comprise a protective cover, arranged to cover and protect at least one of the compression plate, compressible chamber, support, base plate and housing. The protective cover may comprise slots through which the restraints and/or straps can extend.

The protective cover may substantially surround the compressible chamber. The protective cover may be configured to protect the compressible chamber from external pressure (e.g. internal tyre pressure). This may allow the compressible chamber to expand when required. The protective cover may be part of the housing.
The inlet of the compressible chamber may be fluidically connectable to the environment.
The outlet of the compressible chamber may be fluidically connectable to the inside of a tyre.

The inlet may be connected to the environment—i.e. outside of the tyre—via a valve, port or filtration device, for example. The valve, filtration device or port for connection to the inlet may be arranged in a tyre wall, or in the hub of a wheel, or in the tread of the tyre, for example. The filtration device may be a valve—that is, a valve may be considered a type of filtration device.

The filtration device may comprise any type of filter used for filtering air input into a pneumatic system, or fluid input into a hydraulic system. The filtration device may comprise a mesh or gauze for preventing the ingress of dirt or particles into the pump.

The pump may comprise a valve. The valve may be fluidically connectable to the environment for receiving fluid from the environment. The pump may be configured such that fluid can be expelled through a filtration device or valve—for example into the environment—for cleaning the valve. The pump may be configured such that fluid can be expelled from the compressible chamber, through the valve, into the environment. This action may clean the valve.

The pump may be configured to expel fluid through the valve (for example during normal use) to clean the valve.

The present disclosure thus provides for a pump which is capable of cleaning an air intake valve/filtration device—e.g. a valve arrangable to fluidically connect to the environment—during normal use.

The valve may be connected to the inlet of the compressible chamber (e.g. directly or indirectly). The valve may be connected to the outlet (e.g. directly or indirectly).

Fluidic communication between the environment and the pump may be regulated by the valve. The valve may be configured to reduce the ingress of dirt into the apparatus. The valve may be cleanable by fluid expelled into the environment via the valve, for example powered by the operation of the pump.

The valve may be connected to the inlet of the compressible chamber.

The valve may be additionally connected directly or indirectly to the outlet of the compressible chamber. For example such that air can be received into the compressible chamber from the valve and expelled from the compressible chamber through the valve either directly or indirectly.

The pump may comprise a filtration device. The filtration device may be fluidically connectable to the environment for receiving fluid from the environment. The pump may be configured such that fluid can be expelled through the filtration device—for example into the environment—for cleaning the filtration device. The pump may be configured such that fluid can be expelled from the compressible chamber, through the filtration device, into the environment. This action may clean the filtration device.

The pump may be configured to expel fluid through the filtration device (for example during normal use) to clean the filtration device.

The present disclosure thus provides for a pump which is capable of cleaning an air intake filtration device—e.g. a filtration device arrangable to fluidically connect to the environment—during normal use.

The filtration device may be connected to the inlet of the compressible chamber (e.g. directly or indirectly). The filtration device may be connected to the outlet (e.g. directly or indirectly).

Fluidic communication between the environment and the pump may be regulated by the filtration device. The filtration device may be configured to reduce the ingress of dirt into the apparatus. The filtration device may be cleanable by fluid expelled into the environment via the filtration device, for example powered by the operation of the pump.

The filtration device may be connected to the inlet of the compressible chamber.

The filtration device may be additionally connected directly or indirectly to the outlet of the compressible chamber. For example such that air can be received into the compressible chamber from the filtration device and expelled from the compressible chamber through the filtration device either directly or indirectly.

The outlet may be connected to the inside of the tyre—that is the air cavity of the tyre, for example by means of an valve or port.

Fluid may only be ejected from the pump into the tyre when the tyre pressure drops below a threshold pressure value.

The pump may further comprise an output valve fluidically connected to the compressible chamber outlet and for outputting fluid into a tyre. The pump may be configured such that when the pump is attached to the inside surface of the tread of a rolling tyre, fluid is only ejected through the output valve when the tyre pressure drops below a threshold pressure value.

The threshold pressure value may be an optimal tyre pressure.

In addition to examples in which the compressible chamber is not compressed unless the pump is installed in an underinflated tyre, certain examples are configured to only eject fluid through an output valve when the tyre is underinflated. This may be instead of or in addition to the aforementioned systems.

The pump may further comprise a fluid reservoir.

The fluid reservoir may be located between and be fluidically connected or connectable to the outlet of the compressible chamber and the output valve.

The fluid reservoir may be configured to regulate the flow of fluid from the pump into a tyre.

The pump may be configured such that fluid can be expelled from the fluid reservoir, through the valve/filtration device (e.g. the valve/filtration device fluidically connectable to the environment), for cleaning the valve/filtration device.
The output valve may be a one-way valve arranged to prevent fluid flowing from a tyre into the pump.
The fluid reservoir may be arranged to receive fluid ejected from the compressible chamber and output fluid through the output valve. Fluid may be output through the output valve when the pressure in the reservoir is greater than the pressure in the tyre.
The relative volumes of the compressible chamber and the fluid reservoir may be selected such that the pressure of fluid in the fluid reservoir reaches the threshold value when the compressible chamber is fully compressed.
The fluid reservoir may receive fluid ejected from the compressible chamber and output fluid into the tyre through a one-way valve when the pressure in the reservoir is higher than that of the tyre.
The relative volumes of the compressible chamber and reservoir may be selected such that fluid is only output into the tyre when the tyre pressure drops below a threshold pressure value.

The inlet of the compressible chamber may comprise an input valve/filtration device fluidically connected to the environment and for receiving fluid from the environment. The input valve/filtration device may be a two-way valve. The inlet may be a two-way valve.

It is to be understood that where the present disclosure refers to a valve for communication with the environment, that the disclosure applies equally to a filtration device. A valve and filtration device as disclosed herein are considered interchangeable and overlapping in their usage. Any of the valves described herein (e.g. inlet or outlet arranged to communicate with any of the environment, tyre, surrounding wall etc. . . . ) may comprise a filter configured to clean fluid passing therethrough.

A fluid reservoir may be arranged to receive fluid from the compressible chamber. As fluid is ejected from the compressible chamber into the reservoir, the pressure in the reservoir increases. If the pressure in the reservoir is greater than the pressure in the tyre, fluid will flow from the reservoir into the tyre.

The relative volumes or capacities of the reservoir and compressible chamber may be selected such that maximum pressure in the reservoir is equal to the threshold pressure value. The relative capacities of the reservoir and compressible chamber may be selected such that the pressure in the reservoir is equal to the optimal tyre pressure when the compressible chamber is compressed.
The pump may be arranged to prevent or regulate (e.g. restrict, control, reduce) fluid flowing into the compressible chamber from the fluid reservoir when fluid is being drawn into the compressible chamber through the inlet.

Given the peristaltic compression of the compressible chamber, fluid may be drawn in to the compressible chamber from the environment through the inlet (and input valve/filtration device) before fluid can flow from the reservoir to the compressible chamber. That is, the pump may be arranged such that fluid is unable to flow into the compressible chamber through the outlet when fluid is being drawn through the inlet (e.g. at the beginning of the expansion stroke). This may be caused be due to the compressible chamber being fully compressed by the compression plate at the outlet end when the inlet end is expanding.

As the fluid reservoir may be at an elevated pressure and fluid entering the compressible chamber from the environment may be at atmospheric pressure, the fluid in the reservoir and compressible chamber system may be at a higher pressure than atmospheric pressure when the compressible chamber is fully expanded. As such, fluid may flow out of the compressible chamber, through the inlet (and input valve/filtration device), into the environment. This may act to clean the inlet, inlet valve/filtration device or a filter.

The pump may be configured such that fluid is restricted from passing from the compressible chamber out of the inlet as the compression plate moves towards the base plate; and such that fluid can move through the compressible chamber and out of the inlet as the compression plate moves away from the base plate. The pump may be configured such that fluid can move through the compressible chamber from the reservoir and out of the inlet as the compression plate moves away from the base plate.

The pump may comprise a compression surface against which the compressible chamber is compressed by the compression plate. One of the compression surface and the compression plate may comprise a protrusion adjacent the inlet of the compressible chamber. The other of the compression surface and the compression plate may comprise a complementary recess arranged to mate with the protrusion. The pump may be configured such that, during use, the protrusion and recess mate as soon as the compression plate moves towards the base plate, thus restricting fluid from passing from the compressible chamber out of the inlet. The protrusion and recess may be configured to disengage as soon as the compression plate starts to move away from the base plate.

The recess may form part of a groove arranged adjacent to the compressible chamber and running from the inlet to the outlet of the compressible chamber.

The compressible chamber may be configured to fill or expand into or accommodate the recess such that fluid may flow through the recess in the compressible chamber.

The protrusion and recess may be located only at the inlet side/end of the compressible chamber.

The compressible chamber may be formed by a section of an elongated compressible fluid container. The outlet may be a first end of the section and the inlet may be a second end of the section.

The pump of the present disclosure may be part of a multi-pump apparatus. In such an apparatus, any of the components of the pump (e.g. the compression plate, compressible chamber, housing, support, base plate etc) may be formed by part of an elongated component (e.g. an elongated compression plate, compressible chamber, support, base plate etc). That is, a single elongated component may form part of multiple pumps. For example a single, elongated base plate may act as a base plate for multiple different pumps. Equally, a single compressible chamber may, for example, extend around a portion of, or the whole circumference of, a tyre and may form the compressible chamber for each of the plurality of pumps located around the tyre. In such cases, features such as the inlet or outlet may not comprise a distinct feature, but may instead be provided by a region of the compressible chamber located between pumps.

The pump apparatus may comprise a plurality of pumps as described anywhere herein.

Further according to an example is a pump apparatus comprising a plurality of pumps as described anywhere herein connected in series.
The outlet of the compressible chamber of a first pump may be connected to an inlet of the compressible chamber of a second pump.
The pump apparatus may be arranged to peristaltically pump fluid through the plurality of pumps.

Pumps according to the disclosure may be arrangeable in series in order to provide an elongated series of pumps. The pumps may operate independently, or be connected such that fluid from one pump flows through an adjacent pump.

The pump apparatus may comprise two, three or more than three pumps connected in series. The pump apparatus may comprise two, three or more than three pumps arranged on a tyre in parallel.

The pump apparatus may comprise a single input and output (e.g. via a valve), such that fluid flows in and out through a plurality of pumps of the pump apparatus during operation.
The pump apparatus may comprise a single compressible fluid container arranged to form the compressible chambers of each of the pumps.
The pump apparatus may comprise a single elongated base plate arranged to form the base plates of each of the pumps.

The pump apparatus may comprise a single elongated compressible chamber, base plate, compression plate, housing, support or protective casing, which forms the corresponding feature of each individual pump.

A single pump may be advantageously used in vehicles in which gradual depressurisation of the tyres is to be combatted. In such applications, a single, or couple, of pumps may counter gradual depressurisation due to inherent leaks or punctures.

A pump apparatus comprising a plurality of pumps will provide a much greater fluid output and may be for use when rapid reinflation is required. For example, it is common for industrial vehicles to require a low tyre pressure when conducting industrial operations, but a high tyre pressure when travelling on road to/from the industrial site. In such examples, a multi-pump system may be used to rapidly increase the pressure in the tyres when desired.

The activation of such a system, or engagement of such a system, may be controlled by a controller, such that the system can be engaged when rapid reinflation is required.

The pump apparatus may comprise a first pump as described anywhere herein arranged to output fluid into the tyre. The pump apparatus may comprise a second pump as described anywhere herein arranged to receive fluid from the environment and then output fluid into the environment. The fluid may be output to the environment via a valve. Fluid may flow out of the compressible chamber, through the outlet or inlet (and corresponding valve), into the environment. This may act to clean the inlet, inlet valve/filtration device or a filter.

Further according to an example is a tyre apparatus comprising:
a tyre;
a first pump as described anywhere herein, attached to the inside surface of the tread of the tyre; and
a second pump as described anywhere herein, attached to the inside surface of the tread of the tyre; wherein
   the tyre comprises a valve/filtration device for allowing fluidic communication between the first pump and the environment, and the second pump and the environment;
   the inlet of the compressible chamber of the first pump is connected to the valve/filtration device for receiving fluid from the environment; and
   the outlet of the compressible chamber of the first pump is arranged to output fluid to the inside of the tyre; and
   the inlet of the compressible chamber of the second pump is connected to the valve/filtration device for receiving fluid from the environment; and the outlet of the compressible chamber of the second pump is connected to the fluid valve/filtration device for expelling fluid through the valve/filtration device.
A first pump may be arranged to eject fluid into the inside of the tyre and draw fluid in from the environment through a valve/filtration device.
A second pump is arranged to eject fluid to the environment through the valve/filtration device and draw fluid in from the environment through the valve/filtration device.

In a tyre apparatus a first pump may be arranged to take fluid in from the environment and pump it in to the tyre to increase the tyre pressure as described anywhere herein. A second pump as described anywhere herein may be arranged to take fluid in from the environment and output it to the environment through the same valve/filtration device. The second pump may, therefore, act to clean the valve/filtration device. The two pumps may be arranged diametrically opposite each other on a tyre such that after a first half rotation fluid may be pumped into the tyre, half a rotation later the valve/filtration device is cleaned, half a rotation later more fluid is pumped into the tyre etc.

The valve/filtration device may be arranged on the tyre wall, the tread of the tyre or in the hub of a wheel to which the tyre is attached.

If not specified otherwise, examples of the present disclosure may be made out of materials known to be suitable for such purposes, such as rubbers, plastics, metals and composites.

### BRIEF DESCRIPTION OF FIGURES

Examples according to the disclosure will now be described with reference to the following figures, in which:

FIG. 1 depicts a base plate for use in a pump according to the disclosure;

FIG. 2 depicts a support for use in a pump according to the disclosure;

FIG. 3 shows a base plate and a support in an assembled arrangement;

FIG. 4 depicts a compressible chamber for use in a pump according to the disclosure;

FIG. 5 depicts a housing for use in a pump according to the disclosure;

FIG. 6 depicts a further housing for use in a pump according to the disclosure;

FIGS. 7A to 7D shows a compressible chamber 4 and a housing in an assembled arrangement;

FIG. 8 depicts part of a compression plate for use in a pump according to the disclosure;

FIG. 9 shows a compressible chamber, a housing and a compression plate in an assembled form;

FIG. 10 shows a compressible chamber, a housing and a compression plate in an assembled form;

FIG. 11 shows a compressible chamber, a housing, a support and a compression plate in an assembled form;

FIG. 12 shows a compressible chamber, a housing, a base plate, a support and a compression plate in an assembled form;

FIG. 13 shows a compressible chamber, a housing, a base plate, a support, straps and a compression plate in an assembled form;

FIG. 14 shows a pump according to the disclosure;

FIG. 15 is a side view of a pump according to the disclosure installed in a tyre;

FIG. 16 is a side view of a pump according to the disclosure installed in a tyre;

FIG. 17 is a side view of a pump according to the disclosure installed in a tyre;

FIG. 18 is a side view of a pump according to the disclosure installed in a tyre;

FIGS. 19A to 19G schematically illustrate the operation of a pump according to the disclosure;

FIG. 20 is a side view of a tyre apparatus according to the disclosure;

FIGS. 21A and 21B depict components for use in a pump according to the disclosure;

FIG. 22 depicts an elongated base plate for use in a pump apparatus to the disclosure;

FIGS. 23A and 23B are side views of a pump apparatus according to the disclosure;

FIGS. 24A and 24B are side views of a housing for use in a pump apparatus according to the disclosure;

FIG. 25 depicts a pump apparatus according to the disclosure;

FIG. 26 is a side view of a pump apparatus according to the disclosure installed in a tyre;

FIG. 27 depicts compressible chambers for use in a pump according to the disclosure;

FIG. 28 schematically illustrate the operation of a pump according to the disclosure;

FIG. 29 depicts a protective casing for use with a pump according to the disclosure;

FIG. 30 depicts a pump according to the disclosure;

FIG. 31 depicts a connector for use with a pump according to the disclosure;

FIG. 32 depicts a connector for use with a pump according to the disclosure;

FIG. 33 shows a tyre indicating the relative size and position of the contact patch;

FIG. 34 shows the tyre patch distributed around a tyre;

FIG. 35 shows the distance travelled by the tyre tread when the patch flattens the natural curve of the tyre;

FIG. 36 shows a manner in which an anchored pressure plate exerts a progressive force as the tyre patch flattens and extends the sideplates in sequence;

FIG. 37 shows a pump unit anchored to the interior tread of a tyre in side and top view;

FIG. 38 shows a pump unit anchored to the interior tread of a revolving tyre and approaching the tyre patch;

FIG. 39 shows a pump anchored to the interior tread of a tyre and within the contact patch in compression mode;

FIG. 40 shows a pump anchored to the interior tread of a tyre within the contact patch and in vacuum mode;

FIG. 41 shows a pump unit complete with a shaped base plate in front top and side view with semi-transparent bellows pump revealing an optional internal concealed spring return;

FIG. 42 shows a tread lock plate in top side and front view;

FIG. 43 shows a section of tyre and rim with fresh air inlet/control valve and connected air channel;

FIG. 44 shows a tyre lock plate in place within the tyre tread body;

FIG. 45 shows a pump unit locked to the tyre via an intermediate tread lock in top and front view;

FIG. 46 shows a pump unit installed within the tyre interior tread in pump/compression mode in side view;

FIG. 47 shows a pump unit installed within the tyre interior tread in vacuum mode in side view;

FIG. 48 shows a combined apex unit and sideplate units and pressure plate

FIG. 49 shows the base for a multiple pump unit with installed tubular air space and additional semi flexible pressure plate;

FIG. 50 shows a sequence of combined pump units with extended base plate and elongated tubular air space chamber in vacuum mode;

FIG. 51 shows a tread lock unit;

FIG. 52 shows the tread lock unit in place in the interior tread of the tyre;

FIG. 53 shows a pump unit installed via the lock unit in the interior tread of the tyre;

FIG. 54 shows in detail a pump unit in motion generating a peristaltic pressure wave upon a tubular air chamber;

FIG. 55 shows a section of multiple pump units locked inside a revolving tyre tread and within the tyre patch operating sequentially to compress a tubular air chamber to generate a peristaltic pressure wave;

FIG. 56 shows a section of multiple pump units locked inside a revolving tyre tread and exiting the tyre patch operating sequentially to release pressure on a tubular air chamber;

FIG. 57 shows a view of an armored pump unit cartridge in front and side view with pump unit installed;

FIG. 58 shows a view of an armored pump unit cartridge in front and side view (semi transparent) with a sectioned pump unit installed;

FIG. 59 shows a closed/sealed armored pump unit interlocked with a tread lock and with inlet and outlet valves;

FIG. 60 shows a closed/sealed armored pump unit cartridge with inlet and outlet valves installed on the interior of a tyre tread via a tread lock in front and top view;

FIG. 61 shows a top view of two armored pump unit cartridges in sequence array;

FIG. 62 shows a top view of two armored pump unit cartridges in sequence and in parallel array;

FIGS. 63A to 63J illustrate the operation of a further pump according to the disclosure;

FIGS. 64A to 64C illustrate a further pump according to the disclosure; and

FIGS. 65A to 65H illustrate a further pump according to the disclosure.

### DETAILED DESCRIPTION

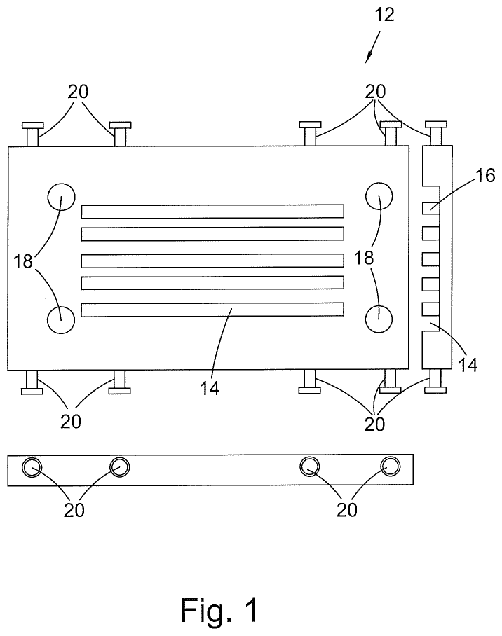

FIG. 1 depicts a base plate 12 of a pump 10. The base plate 12 is for attaching to the inside surface of the tread portion of a tyre into which the pump 10 is to be installed.

The bate plate 12 is made of a flexibly resilient material, for example rubber with similar properties to those of the tyre into which the pump is being installed. The base plate 12 is rectangular with a plurality of grooves or slots 14 formed therein, defining a plurality of ribs 16. The ribs 16 are arranged to engage a support, which is discussed below.

The base plate 12 has a number of holes 18 which may be used as attachment devices for fixing or restraining the base plate 12 relative to the tyre. The base plate also comprises a plurality of anchor points 20 for attachment of a restraint or attachment belt, discussed in more detail below.

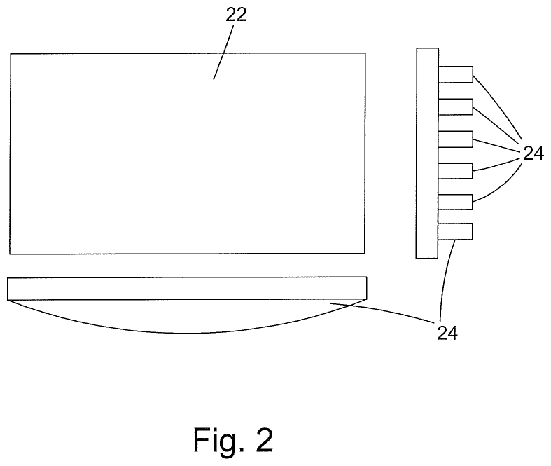

FIG. 2 depicts a support 22. The support 22 is arranged to engage the base plate 12 by means of curved protruding ribs 24 on the support 22 engaging the ribs/slots 14/16 of the base plate 12. The curved profile of the support ribs 24 allow the support 22 to rock or rotate relative to the base plate 12. The support 22 has a flat upper surface for supporting the compressible chamber.

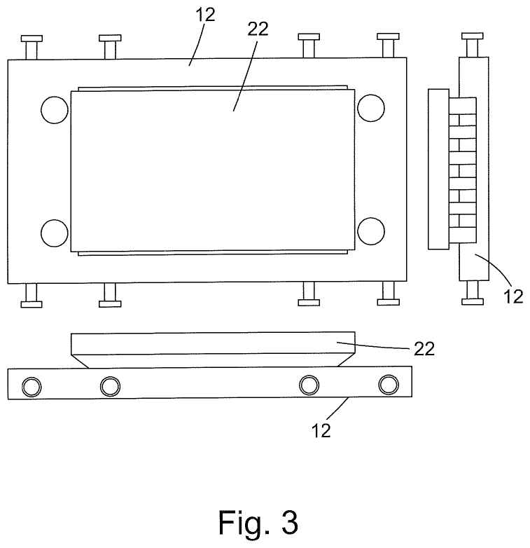

FIG. 3 shows the support 22 engaged with the base plate 12.

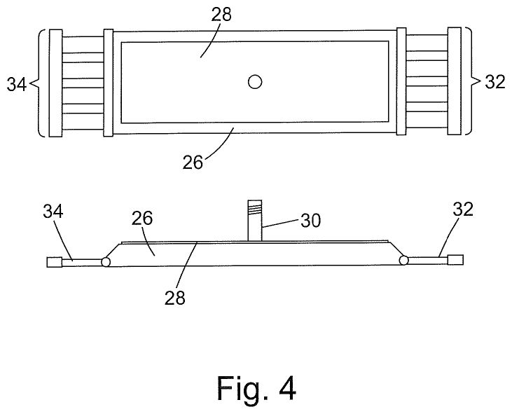

FIG. 4 shows a compressible chamber 26 for use in a pump 10. The compressible chamber 26 is a deformable container for expanding when receiving air and being compressed to eject air. The compressible chamber 26 may be an air sack. The compressible chamber 26 has a length which is arranged to be aligned with the direction of motion of the tyre—that is a circumferential direction. The length is the longest dimension of the compressible chamber 26. The compressible chamber 26 comprises an inlet 32 at a first end and an outlet 34 at a second end, wherein the ends are determined with respect to the length of the compressible chamber—that is in the circumferential direction when the pump is installed in a tyre.

An interface panel 28 is located on top of the compressible chamber 26. The interface panel 28 forms part of a compression plate and has a connector 30 on its upper surface for attaching to a further part of the compression plate. In the present example, the connector comprises a threaded rod.

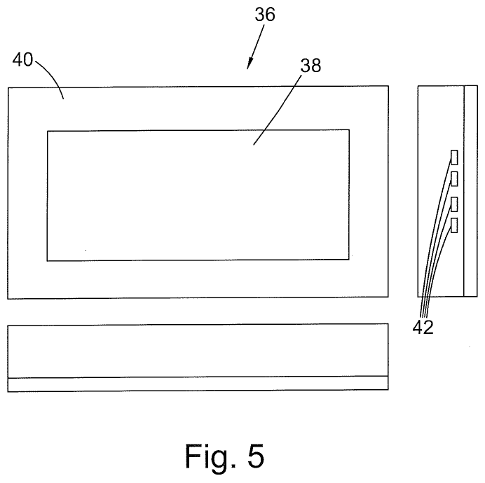

FIG. 5 depicts a housing 36 for the pump 10, comprising a rigid lower plate 38, for being seated on the support 22 and a resiliently deformable surrounding wall 40. Ports 42 are located in either end of the housing 36 through which the inlet 32 and outlet 34 of the compressible chamber 26 extend. In the present example, the housing 36 takes the form of a solid resilient material, such as rubber.

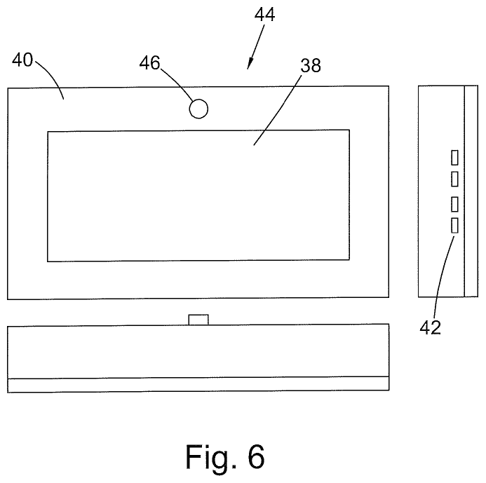

FIG. 6 illustrates an alternate example of a housing 44 suitable for use with the pump 10. This example of a housing 44 comprises a rigid lower plate 38 and a resiliently deformable surrounding wall 40. In this example, the surrounding wall 40 is hollow and is full of air. To this end, the surround wall 40 comprises a one-way valve 46 which lets air into the surrounding wall (in order to ensure the wall is resilient), but does not let air leave the wall 40 and enter the tyre.

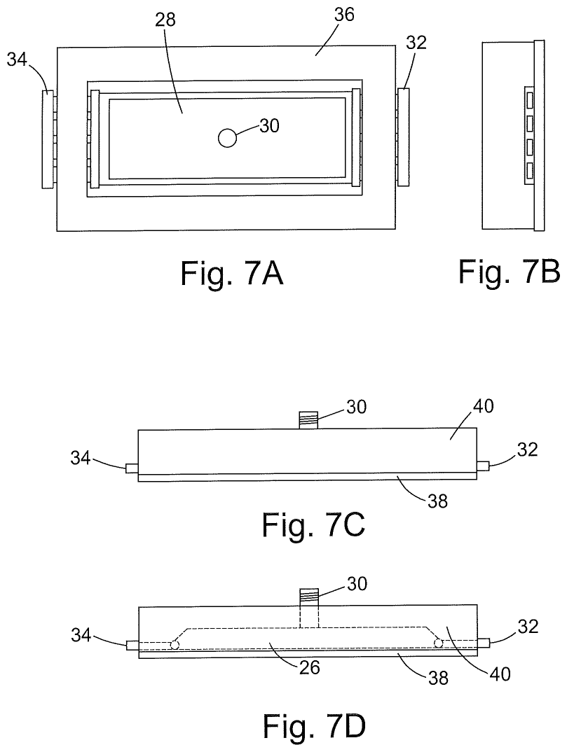

FIGS. 7A to 7D show the housing 36, compressible chamber 26 and interface panel 28 in an assembled arrangement. In FIG. 7D the surrounding wall 40 of the housing is shown as transparent for illustration only.

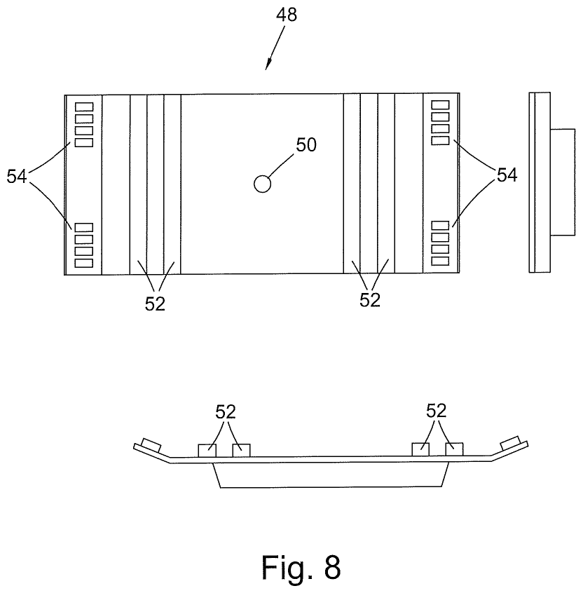

FIG. 8 depicts an upper part 48 of the compression plate, for attachment to the interface panel 28 to form the compression plate. The upper part 48 has an upper surface which is substantially flat with two slightly angled flanges at either end. On the lower section of the upper part is a block portion against which the interface panel 28 abuts.

The upper part 48 comprises a hole 50 through which the connector 30 of the interface panel 28 extends. The upper part 48 has four upstanding ridges 52 which define two channels perpendicular to the length of the pump 10. The channels are for receiving belts and are discussed in more detail below. At either end (with respect to the length of the pump corresponding to a circumferential direction of the tyre) of the upper part 48, attachment devices 54—for example slots or clamps—are formed on the flange portions for attaching the restraints to the compression plate 56 as discussed in more detail below.

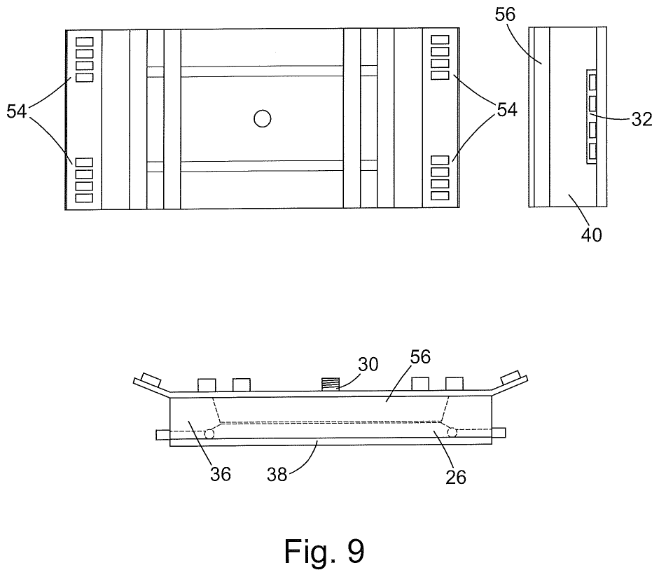

FIG. 9 shows the compressible chamber 26, housing 36, and assembled compression plate 56 in an assembled form. As can be seen, the compressible chamber 26 is located inside the housing 36, seated on the lower plate 38 and surrounded by the surrounding wall 40. The assembled compression plate 56 is located on top of the compressive chamber 26, inside the housing 36. The upper part 48 of the compression plate 56, including the two flanges, is located outside of and above the housing 36, such that the attachment devices 54 are exposed.

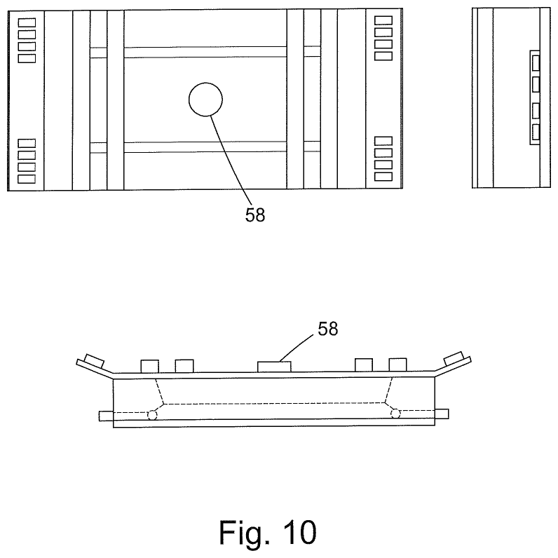

FIG. 10 shows the assembly of FIG. 9 with the addition of a lock nut 58 attached to the connector 30, thus fixing the two parts of the compression plate 56 together.

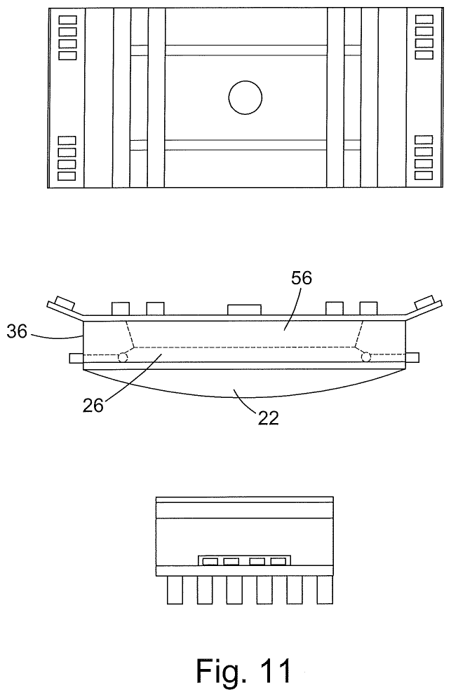

FIG. 11 shows the compressible chamber 26, housing 36, compression plate 56 and support 22 in an assembled form.

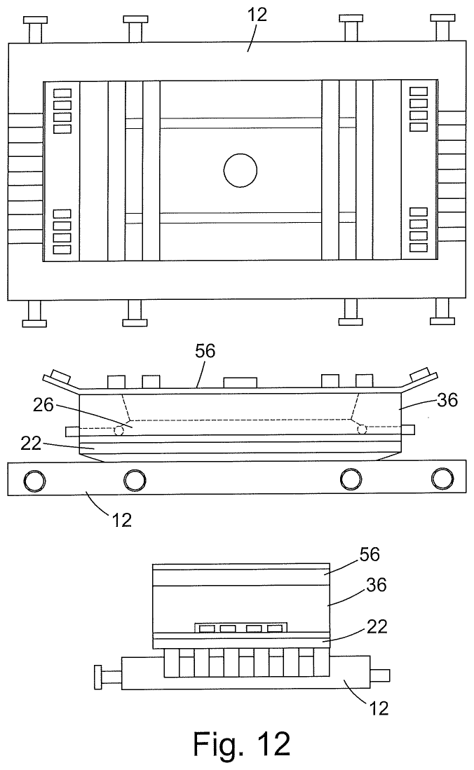

FIG. 12 shows the compressible chamber 26, housing 36, compression plate 56, support 22 and base plate 12 in an assembled form.

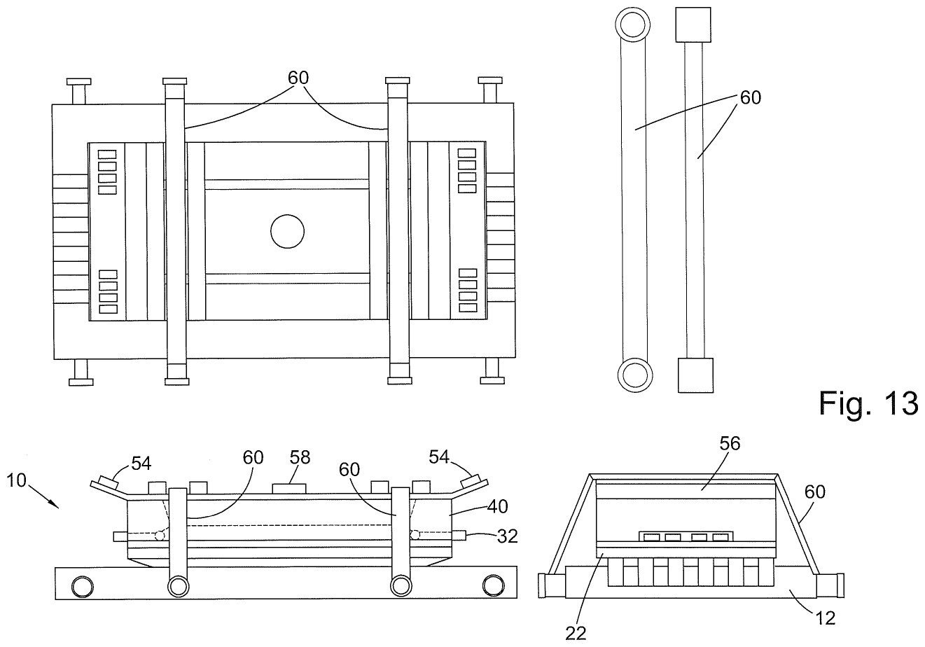

FIG. 13 shows the assembly of FIG. 12 with the addition of first and second straps 60. The straps 60 are attached to anchor points 20 on either side of the base plate 12 and extend over the top of the compression plate 56. The straps 60 run along the channels defined between the upstanding ridges 52 on either side of the compression plate 56. The straps 60 are arranged (e.g. sized and located) such that they maintain the pump 10 in an assembled form, that is, they maintain the compression plate 56 in an engaged arrangement with the upper side of the compression chamber 26, hold the compression chamber 26 and part of the compression plate 56 in the housing 36, hold the housing on the support 22 and the support 22 on the base plate 12. The straps 60 do not exert a force to cause the compression plate 56 to compress the compression chamber 26—as such, the pump 10 is not actuated, causing air to be expelled, by the straps 60. The straps 60 are made of elastic.

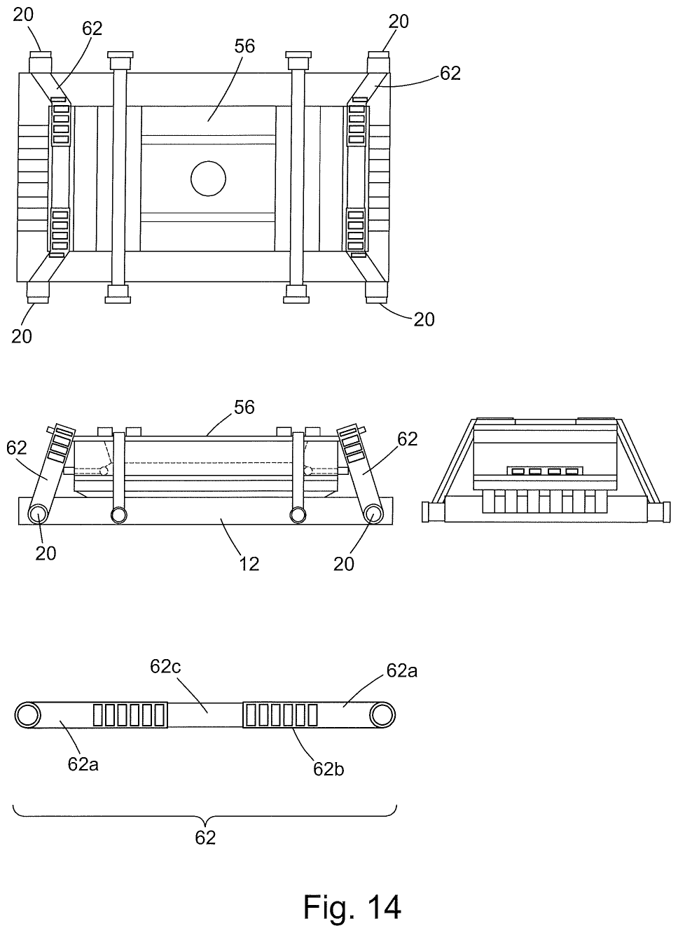

FIG. 14 depicts the assembly of FIG. 13, with the addition of the first and second restraints 62. The restraints 62 are attached to the base plate 12 via anchor points 20 and are attached to the compression plate 56 via attachment device 54 located on either end of the compression plate 56.

Each restraint 62 comprises a central elastic section 62c and two steel belt sections 62a. The steel belt sections 62a each comprise lock points 62b which are configured to engage the attachment devices 54 of the compression plate 56 to fix the restraints 62 thereto.

The restraints 62 are attached to the lengthwise (i.e. in a circumferential direction) ends of the compression plate 56 and are arranges to extend outwards in a lengthwise direction to their respective anchor points 20. That is, the restraint anchor points 20 on the base plate 12 have a spacing that is greater than the length of the pump, compression plate 56 and attachment devices 54 on the compression plate 56. This arrangement is selected in accordance with the tyre in which the pump 10 is installed, as well as the optimal tyre pressure. The arrangement determines the length of tyre contact patch required to cause the compression plate 56 to compress the compression chamber 26, thus causing air to be output from the pump 10 into the tyre. The spacing of the attachment devices 54 and anchor points 20 for the restraints 62, as well as the length of the restraints 62 must be selected such that a tyre contact patch corresponding to an optimally inflated tyre does not cause actuation of the pump 10 as it traverses the contact patch, whereas a tyre contact patch corresponding to an under-inflated tyre must actuate the pump 10 as it traverses the contact patch.

In certain examples, the restraints 62 may be rigid, or semi-rigid, and fixed with respect to both the base plate 12 and the compression plate 56 such that they can actuate the compression plate 56 towards and away from the compression chamber 26.

In the present embodiment, the restraints 62 are adjustable and such the length of the restraints can be selectively varied. This allows a user to select the distance between the anchor point 20 and the compression plate 56, thus varying the minimum contact patch length required to actuate the pump 10.

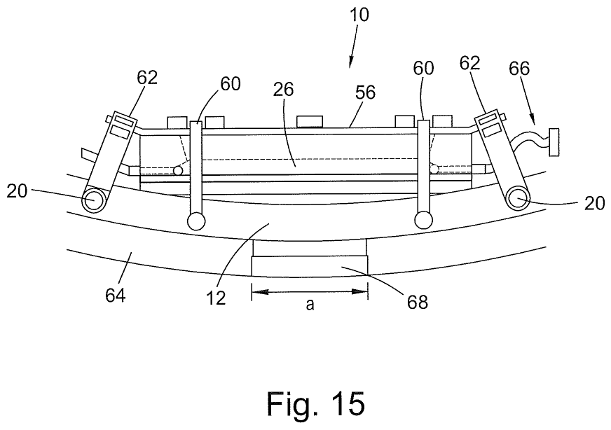

FIG. 15 shows the pump 10 installed on the inside surface of the tread of a tyre 64. The base plate 12 is attached to the inside of the tyre 64 and the remaining components are assembled as previously described. In certain examples the base plate 12 may be integral with the tyre 64.

The inlet 32 of the compression chamber 26 is fluidically connected to an air intake 66. This air intake 66 comprises a valve arranged to allow air to pass from the environment to the pump. The valve may be a one-way valve and may be arranged in the tyre wall or wheel hub. The outlet 34 of the compressible chamber 26 is fluidically connected to the inside of the tyre.

The weight of the tyre and any associated vehicle causes a flat patch at the bottom of the tyre where the tyre contacts the road surface—the contact patch 68. As the tyre 64 rotates, the pump 10 will traverse the contact patch 68 once per revolution of the tyre 64. As the portion of the tyre 64 on which the pump 10 is mounted traverses the contact patch 68, the tyre 64, and hence base plate 12, is deformed. This deformation is manifested in a “flattening” of the base plate 12, reducing the curvature thereof. As the base plate 12 is flattened, the anchor points 20 to which the restraints 62 are attached move away from the corresponding ends of the compression plate 56 and thus pull the compression plate 56 towards the base plate 12—compressing the compressible chamber 26 and ejecting air therefrom. The pump 10 is therefore actuated by the deformation of the tyre 64 and base plate 12 as the contact patch 68 is traversed, provided the deformation is sufficient.

In FIG. 15, the pump 10 is located at the bottom centre of the tyre 64 which is rolling from the left to the right of the figure; the tyre as viewed in FIG. 15 is rotating clockwise and so, in a reference frame fixed with respect to the tyre, the pump 10 is moving from right to left across the contact patch 68. In FIG. 15, the pump is located across a contact patch of length “a”.

The tyre of FIG. 15 is at or above an optimal pressure. As such, the deformation of the tyre 64 is reduced and the contact patch 68, which is of a length “a”, is not large enough to actuate the pump. Specifically, the flattening of the base plate 12, caused by the contact patch 68, is insufficient to cause the restraints 62 to pull the compression plate 56 towards the base plate, compressing the compressible chamber 26. The length of the contact patch (“a”) is therefore less than a threshold length, above which the pump 10 is actuated. As can be seen in FIG. 15, the restraints 62 are taut, but the compressible chamber 26 is not compressed—it is still in an inflated state.

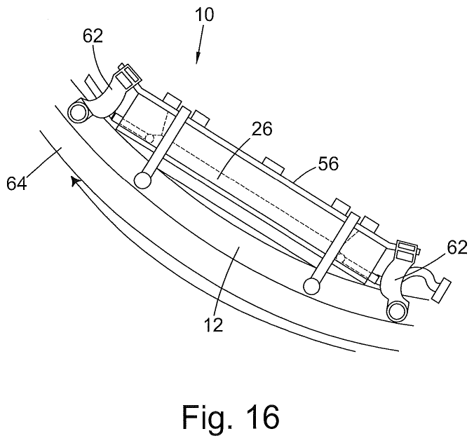

FIG. 16 shows the pump 10 at a time subsequent to that shown in FIG. 15. In FIG. 16, the tyre 64 has rotated further and the pump 10 is no longer across the contact patch—it has traversed the contact patch 68 and is ascending the rear side of the tyre 64. Since the section of the tyre 64 to which the pump is attached is now distal from the contact patch 68, the base plate 12 has a higher curvature. The restraints 62 are no longer taut and the compressible chamber 26 is in an inflated state. If the pump 10 had been actuated as it traversed the contact patch 68 (and hence the restraints 62 had moved the compression plate 56 towards the base plate 12 compressing the compressible chamber 26), once the pump 10 moves away from the contact patch 68 and the restraints 62 slacken, as shown in FIG. 16, the compression plate 56 is free to move away from the base plate 12. The resilient surrounding wall 40 will then move the compression plate 56 away from the base plate 12 and the compressible chamber 26 will inflate, drawing air in via the inlet 32 and air intake 66.

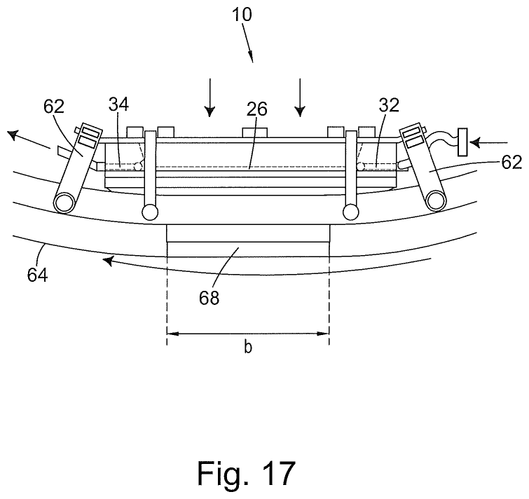

FIG. 17 shows the pump 10 across a contact patch 68 of an underinflated tyre 64. As the tyre 64 is underinflated, the contact patch (of length “b”) is longer than previously and is above a threshold value corresponding to the actuation value of the pump 10. Accordingly, when the pump 10 traverses the contact patch 68, the base plate 12 is flattened and the anchor points 20 of the restraints 62 are moved to such an extent that the compression plate 56 is moved towards the base plate 12, flattening the compressible chamber 26 and expelling air through the outlet 34 into the inside of the tyre 64, inflating the tyre 64. When the section of the tyre 64 to which the pump 10 is attached first enters the contact patch 68, the base plate 12 deforms in the region of the outlet 34 of the compressible chamber 26. This deformation causes the restraint adjacent the inlet 32 end of the compressible chamber to become taut and move the compression plate 56 towards the base plate 12. Thus, the inlet 32 end of the compressible chamber 26 is compressed first, forcing air towards the outlet 34 of the compressible chamber. As the pump 10 spans the contact patch 68, the base plate 12 adjacent the inlet 32 end of the compressible chamber 26 is deformed, causing the restraint 62 adjacent the outlet 34 end of the compressible chamber 26 to be pulled taut, compressing the outlet 34 end of the compressible chamber 26 and expelling air from the compressible chamber 26 through the outlet. The deformation therefore induces a peristaltic compression of the compressible chamber 26.

Once the pump 10 has traversed the contact patch 68, the compression plate 56 is forced away from the base plate 12 and the compressible chamber 26 is inflated, as described above except in reverse—i.e the inlet 32 end of the compressible chamber 26 is expanded, followed by the outlet 34 end of the compressible chamber 26.

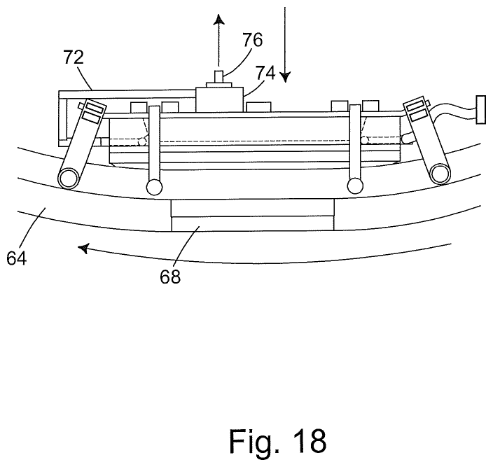

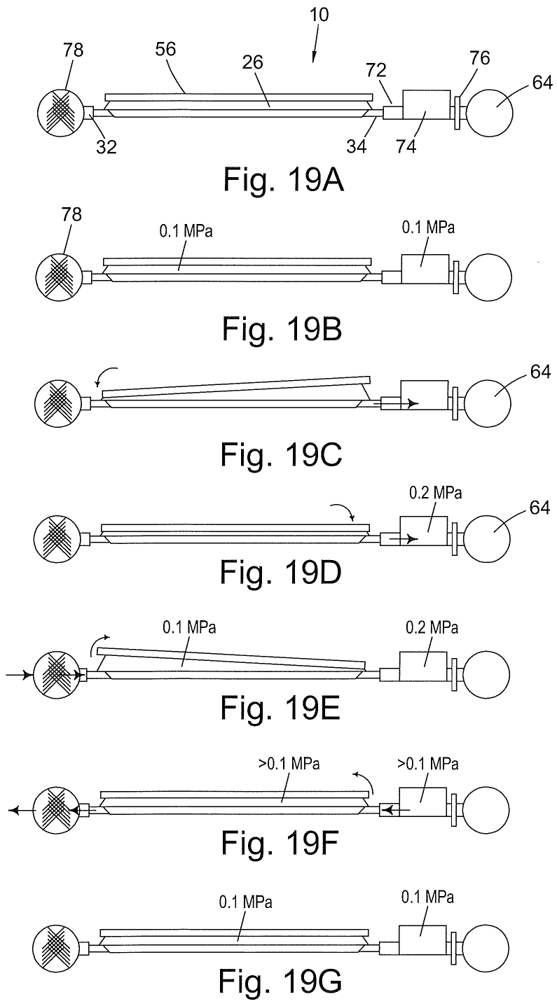

FIG. 18 shows the arrangement of FIG. 17, with the addition of an outlet valve assembly. The outlet 34 of the compressible chamber is fluidically connected to a air reservoir 74 via an air conduit comprising a two-way valve 72. A one-way output valve 76 is located on the air reservoir 74 to permit air to travel into the tyre 64 from the air reservoir 74, but to prevent flow in the opposite direction. The operation of the outlet valve assembly will be explained with reference to FIG. 19.

FIGS. 19A to 19G schematically illustrate the operation of the pump 10 in combination with an outlet valve assembly

FIGS. 19A to 19G are sequential configurations of the pump 10 as it traverses a contact patch 68 in an underinflated tyre.

FIG. 19A shows the pump 10 when the compressible chamber 26 is inflated and the pump 10 is distal to the contact patch 68. The inlet 32 of the compressible chamber 26 is fluidically connected to a two-way valve and an air filter 78 through which air can flow between the pump 10 and the environment (i.e. outside of the tyre). The outlet 34 is connected to the air reservoir 74 via a conduit and two-way valve 72. The reservoir 74 is fluidically connected to the tyre 64 by way of a one-way valve 76 which only permits air flow from the reservoir into the tyre 64. In the example of FIG. 19, the tyre 64 will be assumed to have an optimal tyre pressure of 0.2 MPa. In order to inflate the tyre 64 to and maintain the tyre at this optimal pressure, the compressible chamber 26 and reservoir 74 have the same volume and air capacity.

FIG. 19B shows the pump 10 before it starts to traverse the contact patch 68. Both the compressible chamber 26 and the reservoir 74 contain air at atmospheric pressure, which will be assumed to be 0.1 MPa. The compressible chamber 26 is uncompressed and no air is flowing within the system.

In FIG. 19C, the leading end of the pump 10 (in a lengthwise direction) encounters the contact patch 68 and the base plate 12 starts to deform. This causes the restraint 62 on the inlet side of the compressible chamber 26 to go taut and actuate the compression plate 56. As such, the compression plate 56 on the inlet 32 side of the pump 10 is moved towards the base plate 12 and the inlet side of the compressible chamber 26 is compressed. Air is thus ejected from the compressible chamber 26 into the reservoir 74.

FIG. 19D shows the pump 10 when it is across the contact patch 68. Both sides of the compression plate 56 have been actuated towards the base plate 12 to compress the compressible chamber 26. Accordingly the compressible chamber 26 is fully compressed and the air from the compressible chamber 26 has been ejected into the reservoir 74. Since the compressible chamber 26 and reservoir 74 have the same capacity, the pressure in the reservoir 74 is now about 0.2 MPa. If the tyre 64 is underinflated (<0.2 MPa), the pressure differential across the one-way valve 76 will result in air flow from the reservoir 74 into the tyre 64, inflating the tyre. If the pressure in the tyre is at, or above, 0.2 MPa, the one-way valve will prevent air-flow between the tyre 64 and the reservoir 74.

FIG. 19E shows the pump 10 as it leaves the contact patch 68. Assuming no air has entered the tyre 64 from the reservoir 74, the pressure in the reservoir 74 is about 0.2 MPa. As the pump 10 leaves the contact patch, the base plate 12 begins to return to its undeformed, curved, state. As the outlet end of the pump 10 leaves the contact patch 68, the restraint 62 at the input end of the compression plate 56 slackens and the resilient surrounding wall 40 moves that end of the compression plate 56 away from the base plate 12, expanding the compressible chamber 26. Air from outside of the tyre 64 is sucked through the air filter 78 and into the expanded end of the compressible chamber 26. Since the outlet end of the compressible chamber 26 is still fully compressed by the compression plate 56, no air can flow therethrough. As such, no air can flow from the reservoir 74 into the compressible chamber 26 and the pressure in the reservoir is 0.2 MPa. The pressure in the (expanded) inlet end of the compressible chamber 26 is 0.1 MPa.

Once the pump 10 has left the contact patch 68 and the base plate 12 is no longer deformed, the compressible chamber 26 is fully expanded as shown in FIG. 19F. At this point, the air in the reservoir 74, which is at 0.2 MPa, expands into the compressible chamber 26, which was previously at 0.1 MPa. Accordingly, the equalised pressure within the compressible chamber 26 and reservoir 74 would be >0.1 MPa. Since the environmental pressure is 0.1 MPa, the pressure difference across the two-way inlet valve causes air flow from the compressible chamber 26 into the environment, through the air filter 78. This puff of air escaping the compressible chamber 26 has a cleaning effect on the air filter 78, dispelling any dirt which may have accumulated.

Once air has left the compressible chamber 26 through the inlet 32 and air filter 78, the pressure in the compressible chamber 26 and reservoir 74 is 0.1 MPa again, as shown in FIG. 19G, and the cycle can start again.

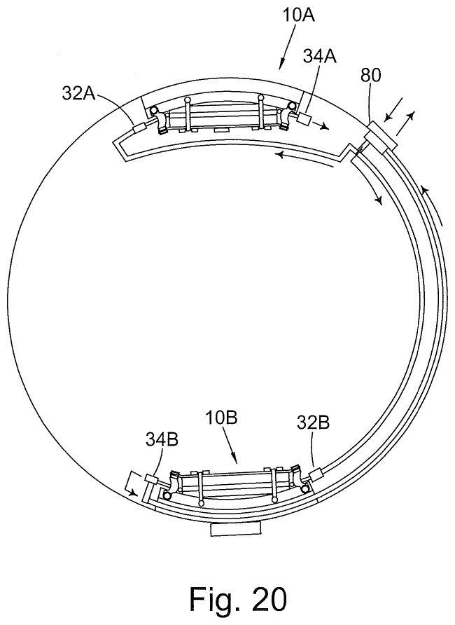

FIG. 20 shows a tyre apparatus according to the disclosure comprising a first pump 10A, a second pump 10B and a tyre valve 80 for fluidic communication between the first pump 10A and the environment and the second pump 10B and the environment. The valve 80 is a two-way valve, allowing air flow in both directions.

The inlet 32A of the first pump 10A is connected to the valve 80 for receiving air from the environment. The outlet 34A of the first pump 10A is arranged to eject air into the tyre to inflate the tyre. The first pump 10A operates as previously discussed to inflate the tyre.

The inlet 32B of the second pump 10B is connected to the valve 80 for receiving air from the environment. The outlet 34B of the first pump 10B is also connected to the valve 80, for ejecting air out through the valve 80.

The tyre apparatus of FIG. 20 therefore has a first pump 10A which acts to inflate the tyre as previously discussed and a second pump 10B which acts to draw air through the valve 80 and then eject air out through the valve 80 in order to clean the valve 80 or an air filter located therein, to prevent the valve 80 from getting clogged.

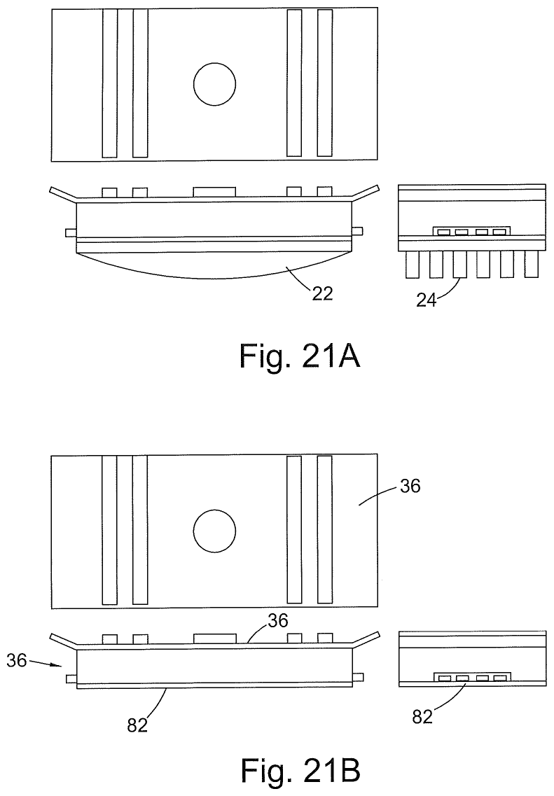

FIG. 21A depicts part of a pump 10 comprising a rigid support 22 with curved lower ribs 24, as shown in FIG. 2. FIG. 21B depicts an alternatively arrangement according to the disclosure in which the housing 36 comprises a flexible lower surface 82 which is attached directly to a base plate 12, without a rigid support 22.

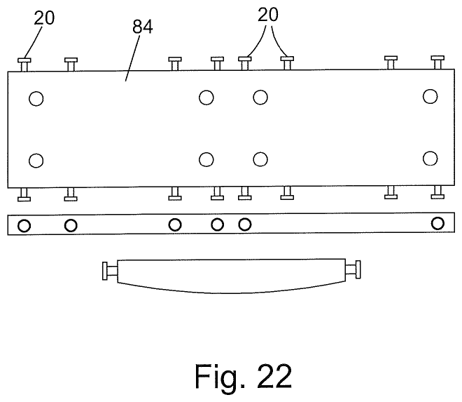

FIG. 22 depicts an elongated base plate 84 suitable for forming the base plate 12 of a plurality of pumps 10. As such, in an arrangement in which an interconnected sequence of pumps 10 are installed in a tyre, a single elongated base plate 84 may be provided, sections of which act as the base plates 12 for respective pumps 10. The elongated base plate 84 comprises a plurality of anchors 20.

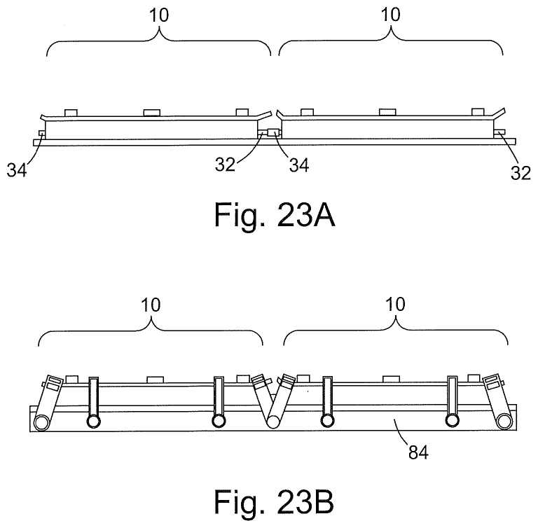

FIGS. 23A and 23B illustrate part of a pump apparatus comprising a plurality of pumps 10 connected in series. In FIG. 23A sections of two pumps are shown without a base plate and they comprise a flexible base as described in relation to FIG. 21B. In FIG. 23B the two pumps of FIG. 23A are shown connected to a single, elongated base plate 84 such as that shown in FIG. 22.

In both figures, the outlet 34 of the compressible chamber 26 of a first pump is connected to the inlet 32 of the compressible chamber 26 of a second pump, such that air is peristaltically pumped through the series of pumps 10 and into the tyre. The shown pumps 10 may only be a section of a longer chain of pumps 10.

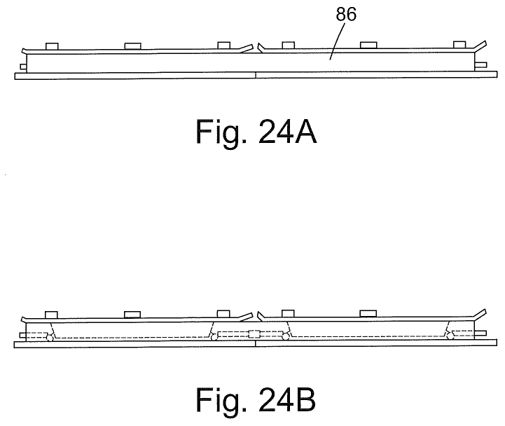

FIGS. 24A and 24B show a chain of pumps 10 housed within a single, elongated housing 86.

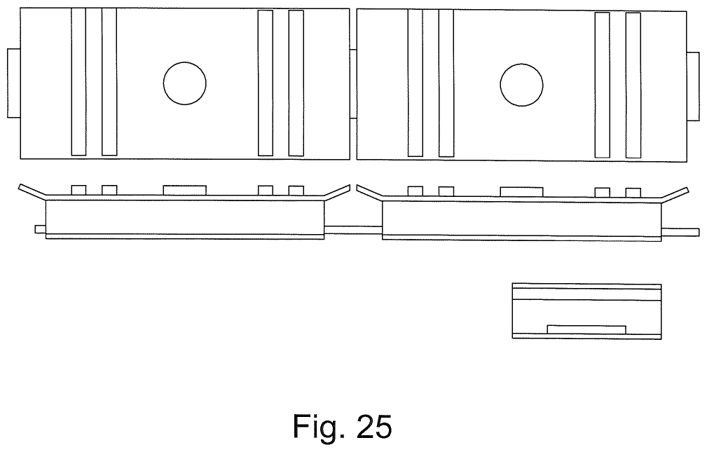

FIG. 25 shows a further chain of pumps 10.

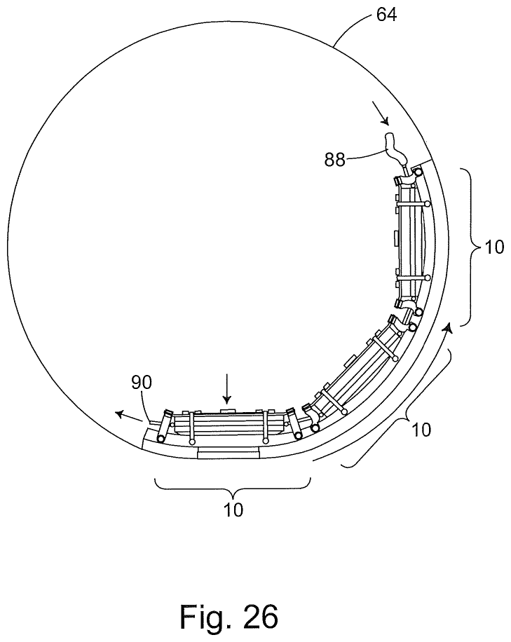

FIG. 26 shows a chain of three pumps 10 installed in a tyre 64. Air flows into the shown chain of pumps through the chain inlet 88 and out of the chain of pumps through the chain outlet 90. As the pumps are sequentially, peristaltically, compressed air flows through the neighbouring pump which, when it is not compressed, acts as a conduit between the active pump and the air outlet (leading to the inside of the tyre).

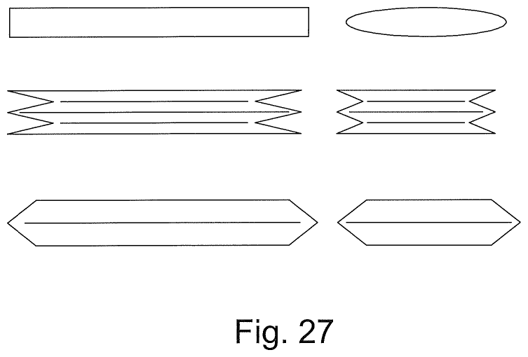

FIG. 27 illustrates exemplar compressible containers 26 of different designs.

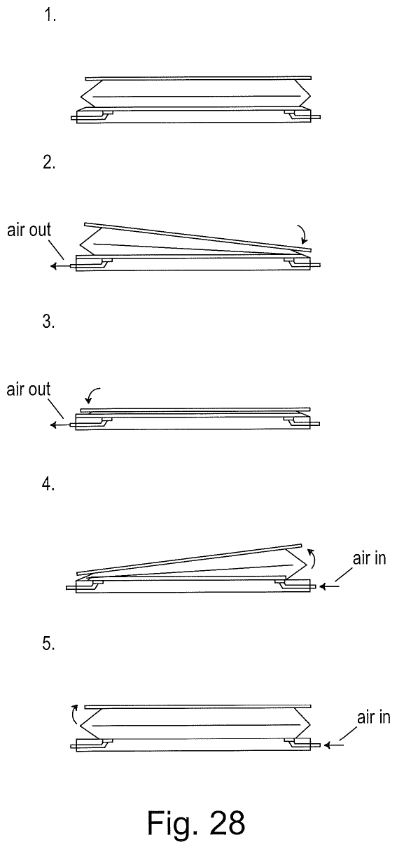

FIG. 28 demonstrates the peristaltic compression of a bellows-type compressible container 26. The sequential compression is comparable to that described above.

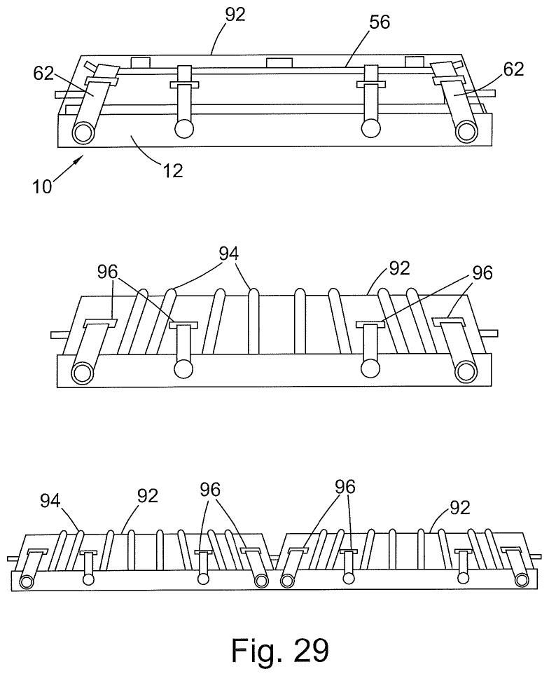

FIG. 29 illustrates a protective casing 92 for a pump 10. The protective casing 92 is attachable to the base plate 12 and comprises a series of rigid ribs 94 which provide rigidity to the casing. The casing 92 may be made of plastic or rubber. The casing surrounds the housing 36, compression plate 56 etc and protects them from damage.

The casing 92 comprises slots 96 through which the straps 60 and restraints 62 extend, in order to attach to the base plate 12 on the outside of the casing 92, but attach to the compression plate 56 on the inside of the casing 92.

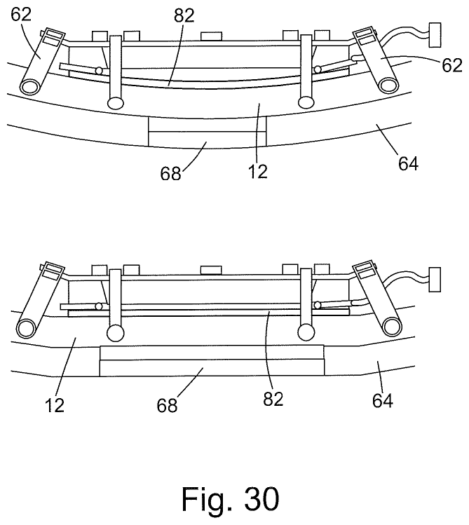

FIG. 30 illustrates a pump 10 as illustrated in FIG. 21B attached to a tyre. The pump of FIG. 30 does not comprise a rigid support 22. Instead, a flexible lower surface 82 of the housing 36 directly attached to the base plate 21, as shown.

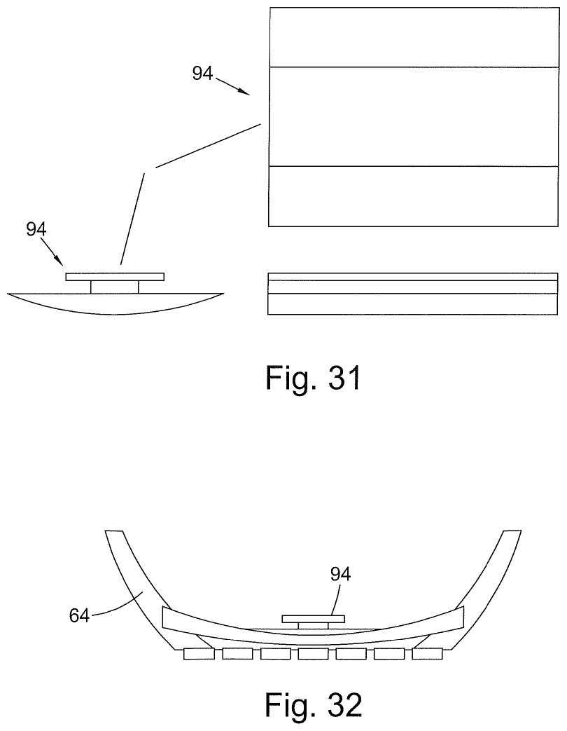

FIGS. 31 and 32 illustrate a connector 94 for use in attaching the base plate 12 to the inside surface of the tread of a tyre 64. The connector 94 comprises an elongated protrusion with a T-shaped profile, for insertion into an elongated slot extending along the base of the pump(s).

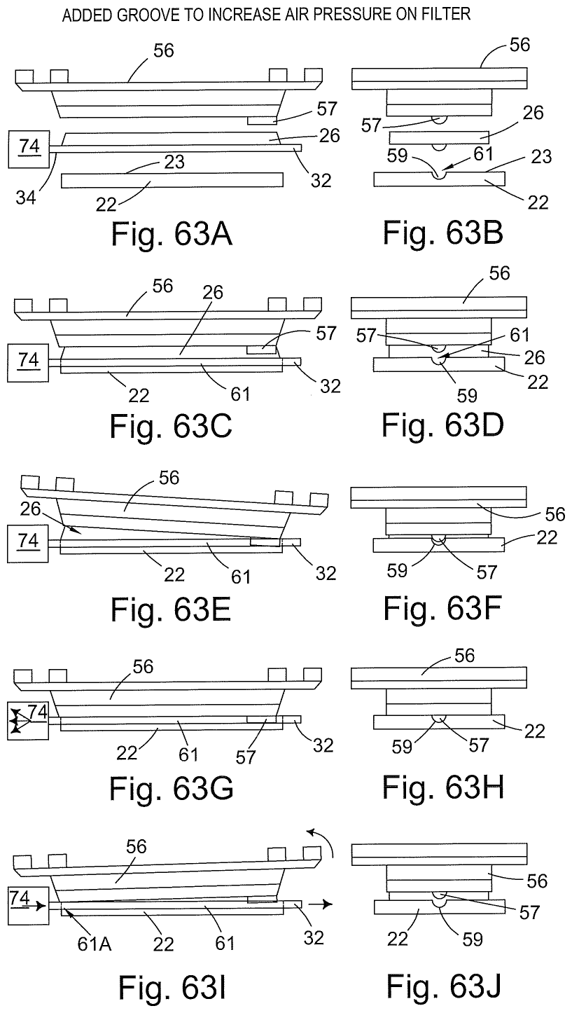

Turning now to FIGS. 63A to 63J, certain features of a further pump is shown. FIGS. 63A and 63B are exploded side and end views of the pump. FIGS. 63C to 63J are side and end views of at a plurality of stages of operation of the pump.

As before, the pump comprises a compression plate 56, compressible chamber 26 and a support 22. In other examples, however, the feature illustrated as the support 22 in FIGS. 63A to 63J may instead be the base plate 12. The upper surface of the support 22 provides a compression surface 23 against which the compressible chamber 26 is compressed by the compression plate 56.

The compressible chamber 26 is arranged between the compression plate 56 and the support 22 and, as in FIGS. 19A to 19G, the pump comprises a reservoir 74 through which air may enter the tyre from the compressible chamber 26. The reservoir 74 of this example may be equivalent to that of FIGS. 19A to 19G.

Also as previously, the inlet 32 of the compressible chamber 26 is fluidically connected to the environment—for example by means of a valve and/or filter.

In the example of FIGS. 63A to 63J, the compression plate 56 comprises a protrusion 57 and the compression surface 23 comprises a complementary recess 59. The recess 59 forms part of a groove 61 which runs adjacent the compressible chamber 26 from the inlet 32 to the outlet 34 of the compressible chamber 26. The compressible chamber 26 is configured to expand into the recess 59 such that fluid can flow through the recess 59 within the compressible chamber 26.

FIGS. 63C and 63D show the pump when the compressible chamber is uncompressed. FIGS. 63E and 63F show the pump as it starts to traverse the tyre contact patch such that the compressible chamber starts to get compressed. FIGS. 63G and 63H show the pump in a fully compressed state. FIGS. 631 and 63J show the pump as the pump starts to leave the tyre contact patch and the pump starts to decompress.

As shown in FIGS. 63E and 63F, as the pump enters the tyre contact patch, the inlet side of the compressible chamber 26 is compressed between the compression plate 56 and the support 22. As can be seen in FIG. 63F, the protrusion 57 mates with the recess 29, thus sealing that end of the groove 61. Furthermore, the edge of the compression plate 56 adjacent the inlet 32 seals against the compression surface 23 of the support 22. Accordingly, air is unable to travel from the compressible chamber 26 through the inlet 32 to the environment. As shown in FIGS. 63G and 63H, as the compressible chamber 26 is fully compressed, air is expelled from the compressible chamber 26 into the reservoir 74. Air may then enter the tyre from the reservoir 74, as described in relation to FIGS. 19A to 19G.

As the pump starts to leave the tyre contact patch, the compression plate 56 moves away from the support 22 in a similar manner to how it approached the support 22. First, the end of the compression plate 56 adjacent the inlet moves away from the support 22. As soon as this happens, the inlet end of the compressible chamber 26 is no longer sealed and air can pass from the compressible chamber 26 through the inlet (e.g. to the environment).

In the example of FIGS. 19A to 19G the outlet end of the compressible chamber 26 was still sealed between the compression plate 56 and the compression surface, preventing air from travelling from the reservoir into the compressible chamber 26 (e.g. through the outlet of the compressible chamber 26). However, in the pump of FIGS. 63A to 63J, the groove 61 runs the length of the compressible chamber 26 and is, accordingly, present under the outlet end of the compression plate 56. As such, even when the compression plate 56 has fully moved towards the support 22, the outlet-end of the compressible chamber 26 is not sealed—i.e. fluid may travel through the outlet end of the compressible chamber 26 by means of the corresponding portion of the groove 61A. This means that as soon as the inlet-end of the compression plate 56 moves away from the support 22, such that the protrusion 57 leaves the recess 59, fluid may flow from the reservoir, through the compressible chamber 26 and out of the inlet 32 of the compressible chamber 26. This allows pressurised air from the reservoir 74 to exit the pump, e.g. into the environment, through the inlet of the compressible chamber, as soon as the compression plate 56 starts to move away from the support 22 (and thus base plate 12).

This also means that the volume into which the air can expand at the time at which it is expelled through the inlet 32 of the compressible air chamber 26 from the reservoir 74 is decreased and thus the pressure of the expelled air is increased—thus improving the valve cleaning properties of the pump. In more detail, in the pump of FIGS. 19A to 19G, the compressible chamber 26 is substantially fully expanded at the point at which the air can leave the reservoir 74 and enter the compressible chamber 26. However, in the example of FIGS. 63A to 63J, the compressible chamber 26 is almost entirely compressed at the point at which air can enter the compressible chamber 26 from the reservoir 74, thus air is expelled through the inlet 32 of the compressible chamber 26 at a higher pressure.

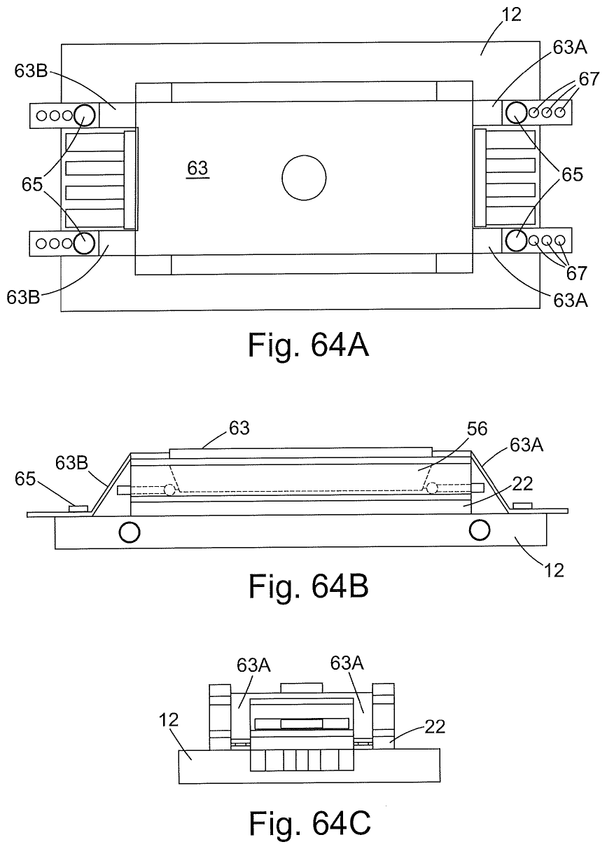

FIGS. 64A to 64C depict a top, side and end view of further pump. The pump comprises a base plate 12 on which a support 22 is located. The compressible chamber 26 is located on top of the support 22 and a compression plate is located on top of the compressible chamber 26, as in other examples of the pump. Other features not described below may be assumed to be similar to those of corresponding examples, above.

The pump of FIGS. 64A to 64C comprises a first restraint 63A connected to the base plate and arranged to engage a first side of the compression plate 56 and a second restraint 63B connected to the base plate and arranged to engage a second side of the compression plate 56. The first and second restraints are part of a single, integral restraint 63, which extends over the top of the compression plate 56 and along the length thereof. The function of the single integral restraint is, however, largely similar to that of two distinct separate restraints.

Either end of the single restraint 63 comprises a plurality of holes 67 arranged to cooperate with a corresponding hole in the base plate 12 and a pin 65 to fix the restraint with respect to the base plate 12. These holes 67 may function to allow the length of the restraint 63 (and hence first and second restraints 63A 63B) to be adjusted such that the pump can operate with a range of tyre contact patch lengths.

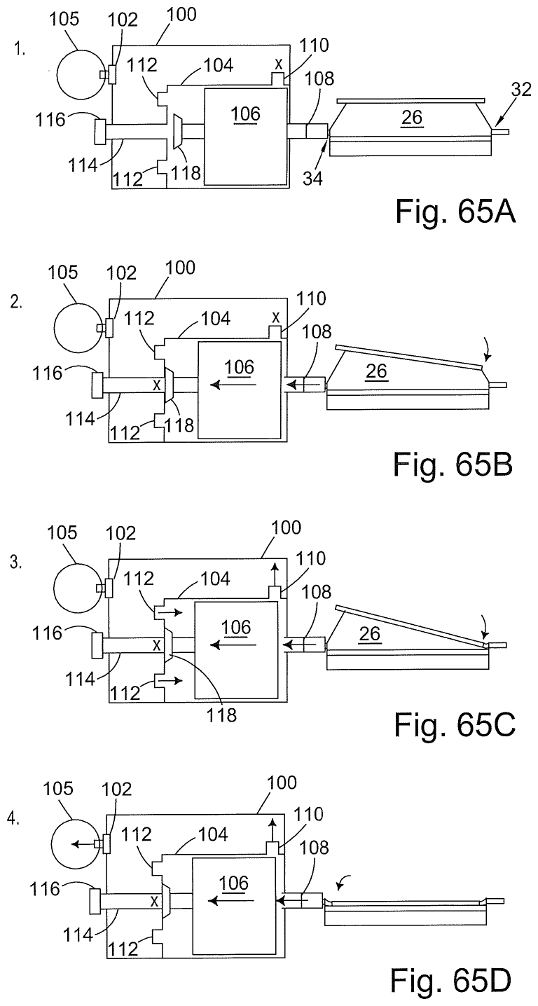

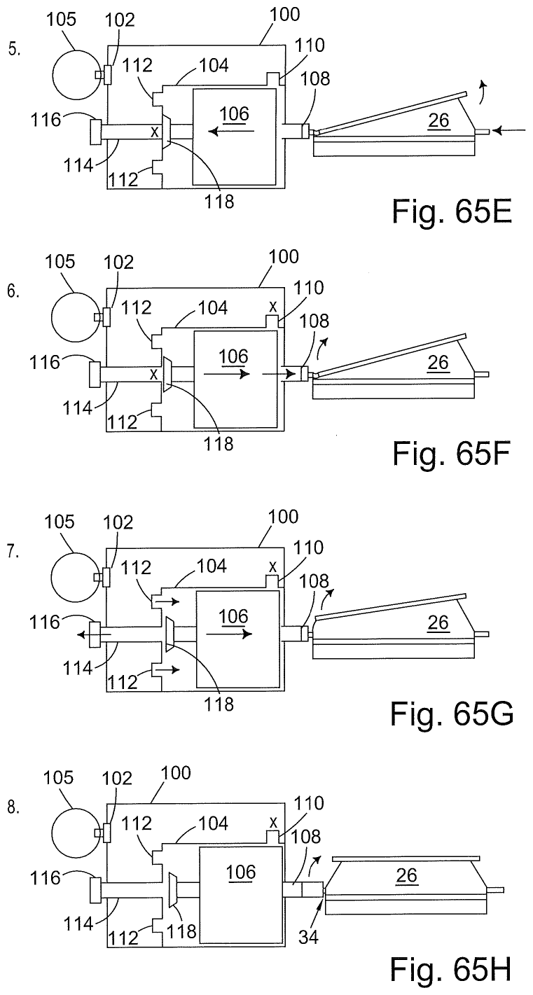

FIGS. 65A to 65H schematically illustrate a further pump including a reservoir 100. The reservoir 100 is fluidically connected to a tyre 105 by means of a one-way tyre valve 102. A piston chamber 104 comprising a piston 106 is located within, or adjacent, the reservoir 100. The piston 106 is arranged to move within the piston chamber 104 under the action of fluid pressure.

The pump also comprises a valve 108 fluidically connecting the compressible chamber 26, from which air may be expelled, to the piston chamber 104. The valve 108 may be a two way valve such that fluid can flow out of the outlet 34 of the compressible chamber 26 and into the piston chamber 104 and from the piston chamber 104 into the compressible chamber 26.

The piston 106 is sealingly arranged within the piston chamber 104 such that the piston 106 separates the inside of the piston chamber 104 into two parts or fluid chambers. A first part is closest to the compressible chamber 26 and thus is able to fluidically communicate with the compressible chamber 26 via the valve 108. A second part is separated from the first part (and hence the compressible chamber 26) by the piston 106. The piston prevents fluid from travelling between the first and second parts within the piston chamber 104.

The piston chamber 104 comprises a one-way reservoir valve 110. The reservoir valve 110 connects the first part of the piston chamber 104 (i.e. that which can fluidically communicate with the compressible chamber 26 via the valve 108) to the reservoir 100 and allows fluid to flow from the piston chamber 104 into the reservoir 100. The reservoir valve 110 is located such that the piston 106 seals or restricts airflow through the reservoir valve 110 when the piston 106 is at the end of the piston chamber 104 closest to the compressible chamber 26 (as shown in FIG. 65A).

The piston chamber 104 further comprises open ports 112 which connect the reservoir 100 to the second side of the piston chamber 104 (i.e. the side of the piston chamber furthest from the compressible chamber 26).

The piston chamber 104 further comprises a flow path 114 connected to a one-way filter valve 116. Fluid flowing through the flow path 114 may be expelled through an inlet to the pump through which fluid enters the pump from the environment. Accordingly, fluid flowing through the flow path 114 and filter valve 116 may be expelled back into the environment and may act to clean the filter valve 116 or inlet valve to the pump system.

The piston 106 comprises a sealing member 118 arranged to move within the piston chamber 104 with the piston 106 to open and close the flow path 114 thus permitting and restricting fluid from flowing therethrough.

The operation of the pump will now be described with reference to FIGS. 65A to 65H. In FIG. 65A the pump is shown with the compressible chamber 26 in a fully expanded state—for example before the compressible chamber approaches the contact patch of the tyre. The piston 106 is located adjacent the end of the piston chamber 104 closest to the compressible chamber 26 such that the sealing member 118 is withdrawn from the flow path 114 and the flow path is open. The piston 106 is arranged to prevent air flow through the reservoir valve 110.

As the pump approaches the contact patch, the compressible chamber 26 starts to become compressed, as shown in FIG. 65B. Air is expelled from the compressible chamber 26 and a pressure gradient is formed across the piston 106, urging the piston 106 to the left of FIG. 65B—away from the compressible chamber 26. This causes the piston 106 to move within the piston chamber 104 such that the sealing member 118 is urged against the flow path 114, sealing the flow path and preventing fluid flow therethrough.

As shown in FIGS. 65C and 65D, as the pump continues to traverse the contact patch the compressible chamber 26 continues to be compressed and air is forced through the valve 108 into the piston 104. Accordingly, the piston 106 moves within the piston chamber 104 away from the compressible chamber 26 into a position in which it no longer restricts air flow through the reservoir valve 110. As such, as shown in FIGS. 65C and 65D, air flows from the piston 104 into the reservoir 100. If the air pressure in the tyre 105 is such that it is less than that in the reservoir 100, air flows from the reservoir into the tyre (see FIG. 65D). During this time, air is restricted from flowing though the flow path 114 by the sealing member 118.

Turning now to FIG. 65E, once the pump has traverse the contact patch, the compressible chamber 26 starts to expand. As shown in FIGS. 65F and 65G the piston 106 is urged towards the right (i.e. towards the compressible chamber 26) as air flows from the piston chamber 104 into the compressible chamber 26. This movement of the piston 106 causes the sealing member 118 to move away from and open the flow path 114, such that air can flow through the flow path and out of the filter valve 116 to clean the valve. Air is also drawn into the piston chamber 104 from the reservoir 100 via the open ports 112 and travels through the flow path 114 under pressure. This air is expelled through the filter valve 116 and out into the environment, thus cleaning the corresponding valve. After the piston 106 has moved fully to the right (see FIG. 65H), it is back in the initial position as shown in FIG. 65A.

Further Disclosure

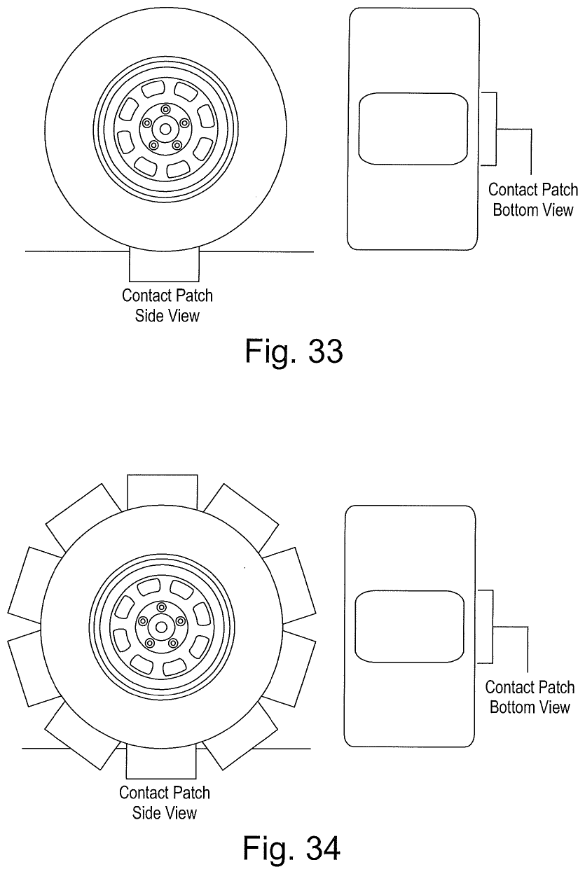

Further disclosure will now be provided, along with description made with reference to FIGS. 33 to 62. It is to be understood that where any conflict or misalignment may occur between terms or features used in the text provided above (and in the claims) and the below text, the text above (and the text of the claims) is considered to be the authoritative and overriding disclosure. Furthermore, it is to be understood that any of the features described below form part of the disclosure and, as such, can be extracted from the specific embodiments described below and combined with elements of the disclosure provided above.

The disclosure relates to the inflation of tyres to prescribed or advised pressures via an interior tyre mechanism. An internal tyre inflation system attached or integral to the interior of the tyre constructed to convert rolling tyre dynamic changes into a pumping mechanism to generate air pressure.

There have been a number of attempts to create a system that pumps air into a tyre via an internal mechanism. Some have linked the tyre to the internal hub others have attached equipment to the outside of the tyre and most recently manufacturers have attempted to build into the tyre structure a flexible tube that generates a peristaltic pump when compressed against the rim. This is the most promising current technology and is shortly to conclude testing in the USA. This system has however problems.

The first problem is that the system must be built into the tyre at the manufacturing stage. This means that only tyres made subsequent to this innovation can operate on the roads. The system proposed in this disclosure differs in that it can be added either at the manufacturing stage or added to any operative and currently available tyre.

A second problem is that building the tube into the bead area of the tyre means the tube is extremely small with the result that the air generated is very low requiring approximately 100 miles to input 5 psi into the tyre.

The system here proposed has no such limitation and can accommodate a large tube or other pump system offering a far greater psi input and more rapid re-inflation. This rapid input of air is especially important in a number of areas such as logging and construction and mining and agriculture where heavy trucks or tractors may wish to vent or deflate their tyres to gain traction and avoid ground/earth/crop compression or the destruction of dirt roads which is documented to result from high pressure tyre rolling; this being a process which is actually reversed when soft tyres are in use. A rapid input of air would allow this venting in so far as the tyre could then be reinflated to the correct pressure when road conditions change to tarmac and the like.

A further disadvantage of an existing system's low air input rate is that where a tyre has a slow puncture the system cannot maintain pressure. That means a flat and a wheel change. Using the current proposed system a slow leak would be more likely to be equalled or exceeded by air input enabling the vehicle to complete its journey.

A third problem with an existing system is that because the pump is inbuilt into the fabric of the tyre any problems or failures cannot be rectified. The current proposed system gives open access within the tyre and can be replaced or repaired simply and quickly.

A fourth problem is an existing system depends on an electronic regulator which monitors air pressure in the tyre and turns the pump on and off. Such a monitor is prone to failure or poor performance. In contrast the current proposed system is able to use a simple air pressure valve to open and shut the pump.

A further problem with the electronic regulator is that in a recent design change this is now to be placed outside the tyre rather than inside. This leaves it open to vandalism or accidental damage or theft. By contrast the current proposed system employs only a single air intake and filter valve outside of the tyre or fitted to the rim.

The present disclosure seeks to overcome the limitations of this and other systems by providing a simple robust pump or pump array easily installed and accessible within the tyre and providing a substantial volume of compressed air directly or indirectly to the tyre.

There is provided a modular Tyre Inflation System comprising a pump unit or mechanism substantially in the form of a triangular structure having a number of component parts such parts including two full or partial sideplates in the form of solid units or optionally in the form of struts or a combination thereof.

Such sideplates being connected together at their top end via an apex unit either rigidly or such that one or more sideplates can move or pivot or revolve independently via the said apex unit such sideplates having at their bottom end one or more connector or lock or clamp units such clamp units being positioned at the base edge of the sideplates or optionally positioned on struts extended from the sideplates or optionally attached to straps or wire belts or other such flexible units such belts being optionally reinforced and overlaying or being integrated with or being otherwise closely attached or connected or closely aligned with the sideplates.

In addition the present disclosure provides that the said sideplates and any associated elements by way of clamp units and the like may be flexible semi-flexible or rigid or any combination thereof. In addition the present disclosure provides that the said clamp units be attached or attachable or anchored or anchorable to a flexible or semi flexible base plate such base plate being so shaped or configured as to be connectable to or attachable to or securely linkable to or otherwise placed in proximity to the interior tread area of a vehicle tyre or connectable or attachable or otherwise securely linkable to an intermediate lock plate or lock unit such lock unit being in turn securely connectable anchorable attachable or otherwise securely linkable to the interior tread area of a vehicle tyre by chemical or physical or interlocking or other such means including vulcanised fusion and or compression moulding.

In addition the present disclosure provides that the said clamp units may be also directly connected or attachable or anchorable to the interior body of a vehicle tyre tread. Such pump unit as previously described having in addition an integral piston unit in the form of a variable shaped piston arm or ram arm or pump arm such pump arm being moveably or rigidly connected or attached to the apex unit and or one or other or both sideplates.

Such pump arm having in addition a bottom piston head or pressure plate such pressure plate being attached to or resting upon a compressible air space chamber in the form of a bellows or a piston membrane chamber or air tube or the like such air space chamber being optionally enclosed in a sealed container or otherwise protected from outside pressure or dust or dirt by protective materials and or structures.

Such air space chamber further having connected valves so configured as to allow air to flow into the space when the space is expanded as in the case of a vacuum pump cycle and compressed air to flow out of the space when the space is compressed as in a compressive pump cycle.

The components of the previously described pump unit being so configured that the movement of the clamp units in a downward and or outward direction moves the apex unit and pump arm and pressure plate downwards in a substantially vertical manner and is further configured that the movement of the clamp units in an upward and or inward direction moves the apex unit and pump arm and pressure plate upwards in a substantially vertical manner.

Such movement as described being provided or caused by the deformation of the patch area of the inner tyre tread as it flattens when in contact with the road or other surface and such movement being transmitted to the pump unit via the clamp units and associated and connected sideplates as a consequence of their secure connection or anchoring or locking to the inner tyre tread.

The present disclosure further provides that the said sideplates are so configured that the sequential movement of the clamp units in a downward and/or outward direction may move the piston unit and pressure plate downward in a manner such that one edge of the pressure plate is pressed down prior to a second opposite edge such differential or sequential pressure having the effect that pressure exerted by the pressure plate is incremental and sequential from one side or edge to the other across the pressure plate.

And in addition that a sequential movement of the clamp units in an upwards and/or inwards direction may move the piston unit and pressure plate such that one edge of the pressure plate is raised or released before the second opposite edge such that the pressure released by the pressure plate is incremental and sequential from one side or edge to the other across the pressure plate such movement having the effect of a rolling or sequential pressure on a connected air space chamber most especially in the case of an elongated air space chamber such as a tube or the like.

The present disclosure further provides that such pump unit as is herein described may be duplicated or replicated and placed together in close or connected proximity such as to act as a multiple pump mechanism such multiple pump mechanism being so configured as to act as a sequential single pump in the manner of a segmented peristaltic pump where the underlying air space chamber is tubular or elongated.

In addition the present disclosure provides that where the air space is tubular or elongated and two or more pump units are employed in close sequence the system may employ a second flexible or semi flexible pressure plate with an elongated form positioned between the pump pressure plate and the underlying air space chamber and configured to provide continuity of pressure in the transition between the discrete pressure exerted by the individual pressure plates of adjacent pump units.

The present disclosure further provides that valves attached or connected to a given air space chamber within the pump unit whether tubular or elongated or bellows or piston membrane or other such forms of compressible air spaces may include valves which regulate the inlet and outlet of air and in addition may include other valves or devices both electronic and mechanical that control regulate or optionally automate the action of the pump or pumps in relation or in response to a given or calibrated or predetermined air pressure inside a given tyre in which the pump or pumps are acting or in response to a given or calibrated or predetermined alteration in the shape of the tyre including the sidewalls and tread.

Such valves or tyre shape alteration having the means to activate or deactivate the pumping action of the pump unit and in addition having a means to allow air to vent from the tyre into the outside atmosphere as well as to draw air into the tyre from the outside atmosphere. Further all and any such valves as previously referred to may be controllable wirelessly such control being optionally automated according to predetermined criteria or by way of manual intervention by an operator or optionally a combination of the two methods.

In addition such valves may include control and movement mechanisms such as solenoids and switches and latch mechanisms and the like. In addition such valves may be powered by a variety of means including but not exclusively solar power or battery power or other such generating or storage type energy or power sources.

In addition such power may also be optionally generated by way of the motion or movement or revolution or deformation of the tyre or by way of energy otherwise generated when the tyre and attached wheel is in motion for example via induction or via a dynamo or other such technology which harnesses and transforms other forms of available energy into electrical current and the like.

In addition the present disclosure provides that the pump unit herein described whether in single or multiple formation may be protected by a secure protective or armoured covering in the form of a sheath or a cartridge or the like such as to form a closed secure unit such armour being either rigid or flexible or semi-flexible or a combination thereof and being configured to house valves or other devices employed by the pump unit either internally or externally or in combination or partly in combination thereof such that the said valves or devices may be accessible from the exterior of the armour.

Such protective or armoured enclosure or sheathing or cartridge-like arrangement being further so configured as to enable the entire pump unit assembly and associated components devices and valves to be handled and installed or removed from the tyre in a manner with the convenience of cartridges employed in other industries for example printers and the like.

Such cartridge in addition having a shape and design or material composition as to be readily attachable to or connected with or lockable to the interior body of a tyre in the area of the interior tyre tread. Such lockability being either by way of direct connection or attachment to the interior body of the tyre or via an intermediate lock unit located within the tyre and securely attached or attachable or otherwise connected to the tyre body via hot and or cold vulcanisation or physical anchors or anchor points or a combination thereof or other such common and secure methods of fixing to the interior body or interior tread of a tyre. Such lock unit being so configured as to allow a further secure locking or fixing or anchoring of the cartridge to the lock unit in a simple and convenient manner for example via compatible shaped interlocking.

In addition the present disclosure provides that the cartridge form of armour may be securely sealed and optionally have a means to be pressurised internally to a PSI level such as is judged to assist the maintenance of the structural integrity of the cartridge in relation to the force or pressure of pressurised air within the tyre itself. In addition the present disclosure provides that such cartridges or similar units whether containing one or more pump units may be connectable to each other in a form that permits the passage or air from one to the other and such passage being optionally regulated via the structural design of the transfer or passage connection and or by valves and the like.

In addition the present disclosure provides that air sourced from outside the tyre and compressed by one or more pump units positioned within the tyre may be vented or injected or passed directly into the interior of the tyre or passed into a storage container or storage unit within the tyre. Such storage unit having a means to thereafter release air into the tyre by way of a control valve or regulator or other such valve or device including but not exclusively valves and devices that are automated or remotely controlled or wirelessly operated or a combination thereof such automation and or remote control including direct operation or intervention by an operator or further by prior calibration.

Such pump unit and system as herein previously described further providing that the said system may include a range of safety and or override and or control and or monitoring systems including data and system status indicators or other such informational interfaces and such interfaces being optionally accessible from within a given vehicle on which the pump unit system is installed or optionally from a remote location via a wireless or internet or other such electronic or digital data reception and transmission method.

Furthermore according to the present disclosure the method by which the pump generates pressured air via the movement of the pressure plate and compression of an air chamber is variable and includes acting upon an air chamber within a closed or sealed or semi-sealed structure or casing such casing being configured to provide for the positioning of various valves in the casing body such as an air inlet valve connected to the outside of the tyre and an air outlet valve connected to the inside of the tyre.

The present system further provides that the pump action of the pump unit may be assisted in the return or vacuum stroke by a spring or springs or sprung material or other such forms of kinetic or mechanical or elastic stored energy and release systems such stored energy and release systems being provided in various forms including within the material around or close to the air space chamber or in close relation to it and including systems related to the deformation of the tyre when in motion.

In addition the current disclosure provides that the pump unit or units whether in individual or multiple form including but not exclusively in the form of a contained cartridge or cartridges be arrayed and sized and generally aligned within a part or whole of the internal tread area in a manner that accords with the optimum size of the tread patch in a fully and correctly inflated tyre or such tread patch size as is designated by the vehicle operator from time to time.

Such alignment being so calibrated that the individual length size dimensions and or positioning of a given pump unit or multiple arrayed pump units may be calculated to activate or deactivate the pump mechanism in accordance with the size and shape of the tyre patch in addition to or as an alternative to a given PSI within the tyre. Such calculation optionally including one whereby when the patch length exceeds the length of the pump base plate or the position of the clamp units or on the basis of other such patch related criteria the pump or pumps are activated.

And in reverse where the patch length is less than the length of the base plate or the positioning of the clamp units or on the basis of other such related criteria the pump or pumps do not operate or cease to operate. Such activation or deactivation of a pump or pumps being a consequence of the compression plate being able or unable to exert a full compression stroke when the underlying air chamber is tubular and the pump action peristaltic or quasi peristaltic.

Such alignment and calculation providing an optional means to regulate and or automate the operation of a given pump unit or multiple pump units such that compressed air is generated and added to the tyre when deflation elongates the tyre patch and is not generated or added to the tyre when the patch is shortened. Such movements being in agreement with the observation that any given tyre patch will elongate structurally when the PSI of the tyre goes down and the tyre deflates.

In addition the said disclosure provides that valves employed within the system may utilise one or more air filters to remove or prevent debris from entering the pump system. In addition the said disclosure provides that individual components of the system such as valves and batteries and regulators and electronic monitors or control units and the like be optionally positioned or partly positioned on the outside as well as on the inside of the tyre and or rim structure and further that protection from damage or theft of such external or partly external components may include a destruction-by removal logic.

FIG. 33 shows a tyre indicating the relative size and position of the contact patch

FIG. 34 shows the tyre patch distributed around a tyre

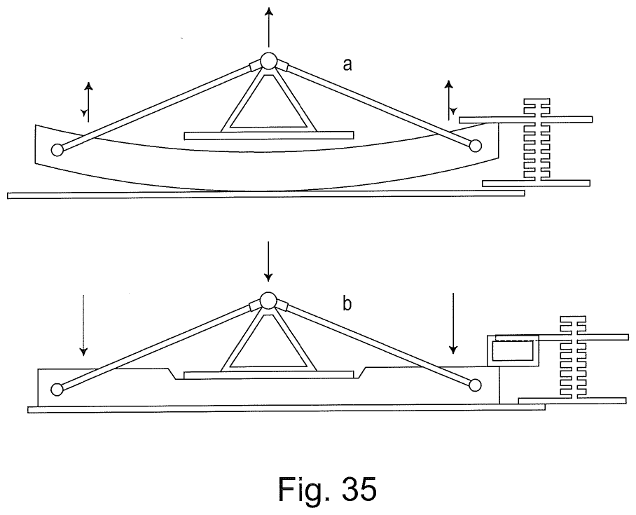

FIG. 35 shows the distance traveled by the tyre tread when the patch flattens the natural curve of the tyre

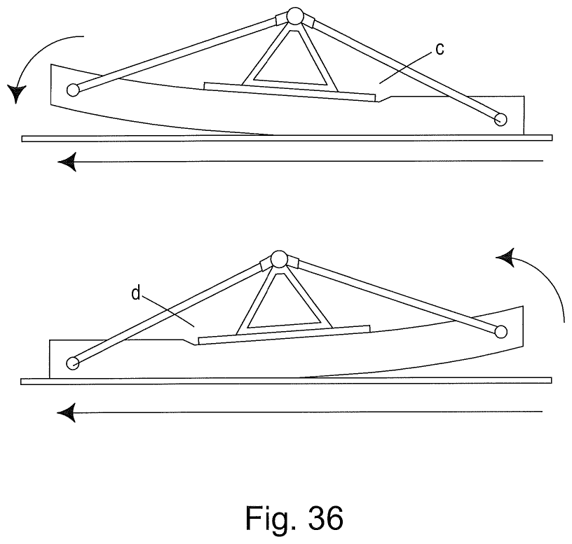

FIG. 36 shows the manner in which an anchored pressure plate exerts a progressive force as the tyre patch flattens and extends the sideplates in sequence

FIG. 37 shows the pump unit anchored to the interior tread of a tyre in side and top view

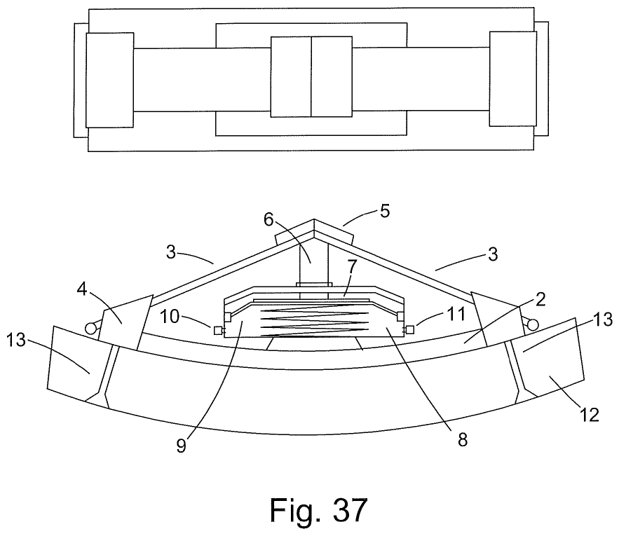

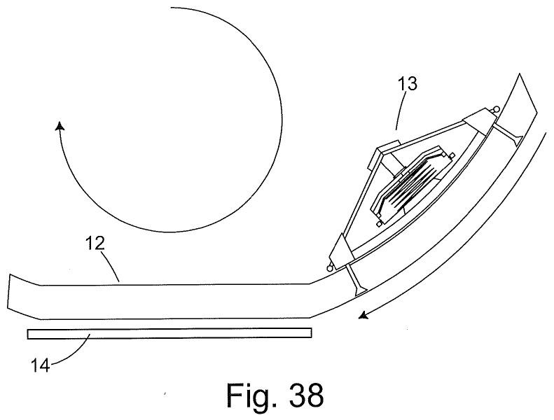

FIG. 38 shows the pump unit anchored to the interior tread of a revolving tyre and approaching the tyre patch

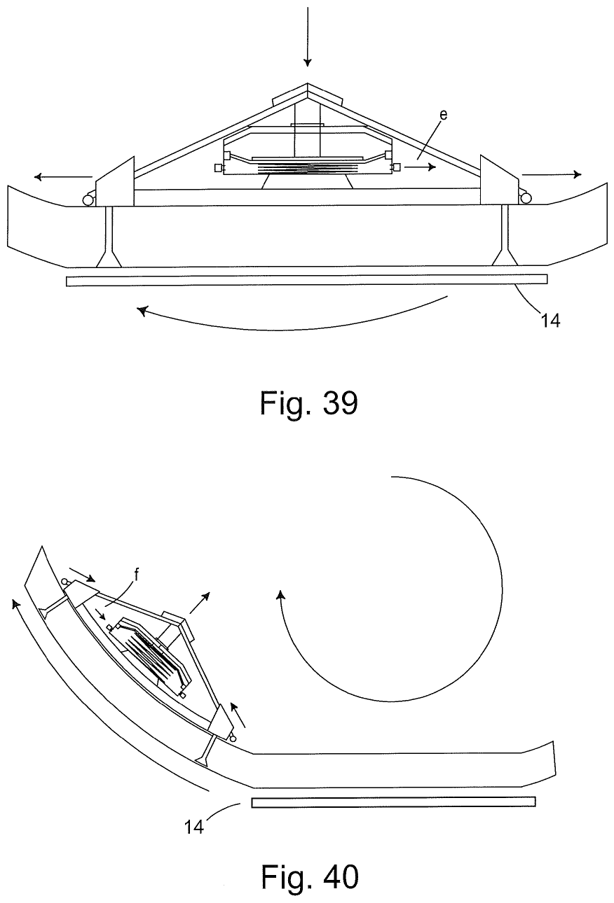

FIG. 39 shows the pump anchored to the interior tread of a tyre and within the contact patch in compression mode

FIG. 40 shows the pump anchored to the interior tread of a tyre within the contact patch and in vacuum mode

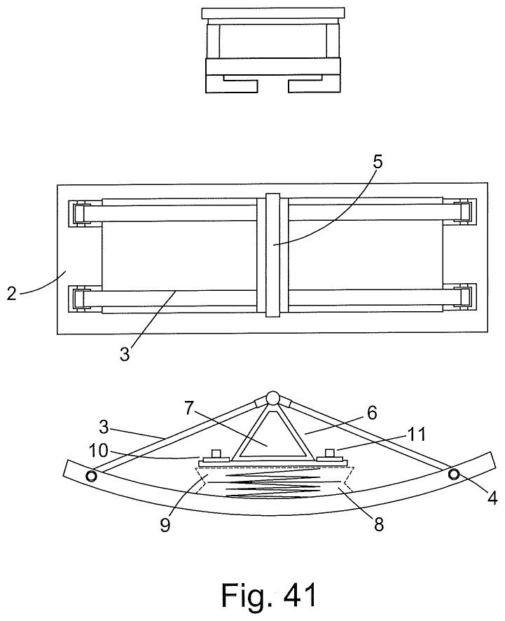

FIG. 41 shows the pump unit complete with a shaped base plate in front top and side view with semi-transparent bellows pump revealing an optional internal concealed spring return

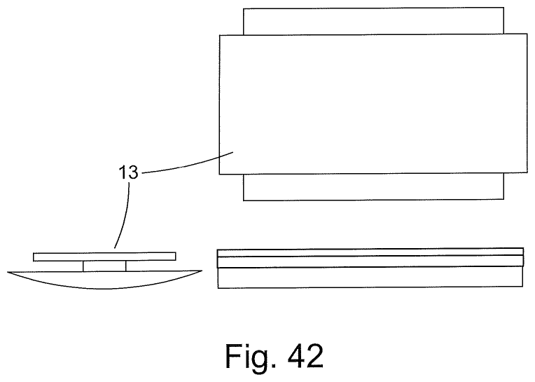

FIG. 42 shows the tread lock plate in top side and front view

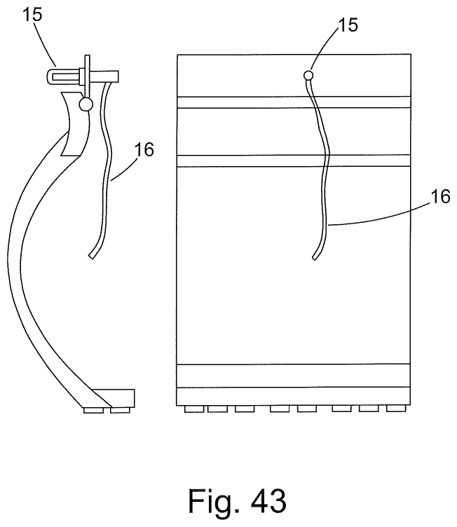

FIG. 43 shows a section of tyre and rim with fresh air inlet/control valve and connected air channel

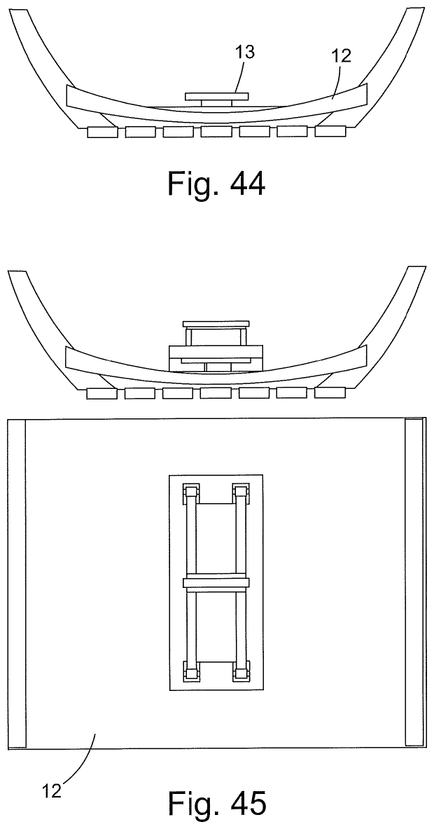

FIG. 44 shows the tyre lock plate in place within the tyre tread body

FIG. 45 shows the pump unit locked to the tyre via an intermediate tread lock in top and front view.

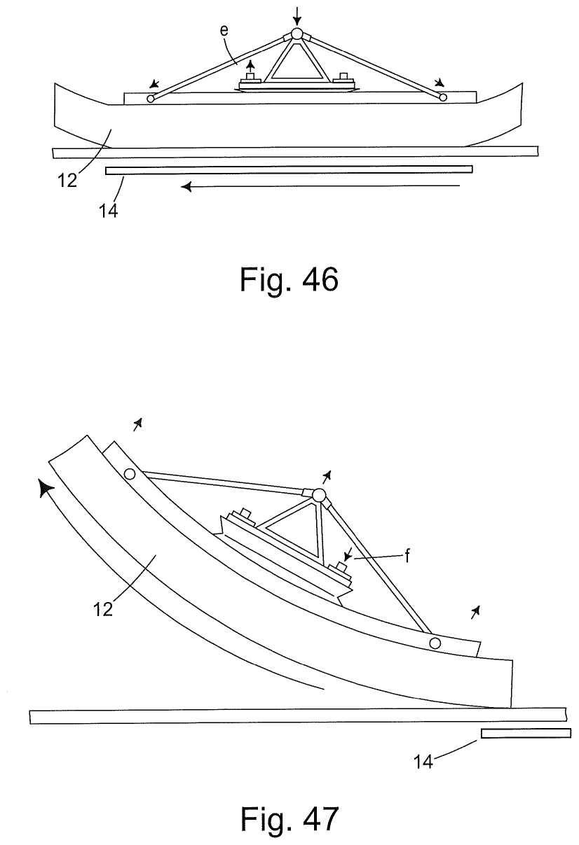

FIG. 46 shows the pump unit installed within the tyre interior tread in pump/compression mode in side view

FIG. 47 shows the pump unit installed within the tyre interior tread in vacuum mode in side view

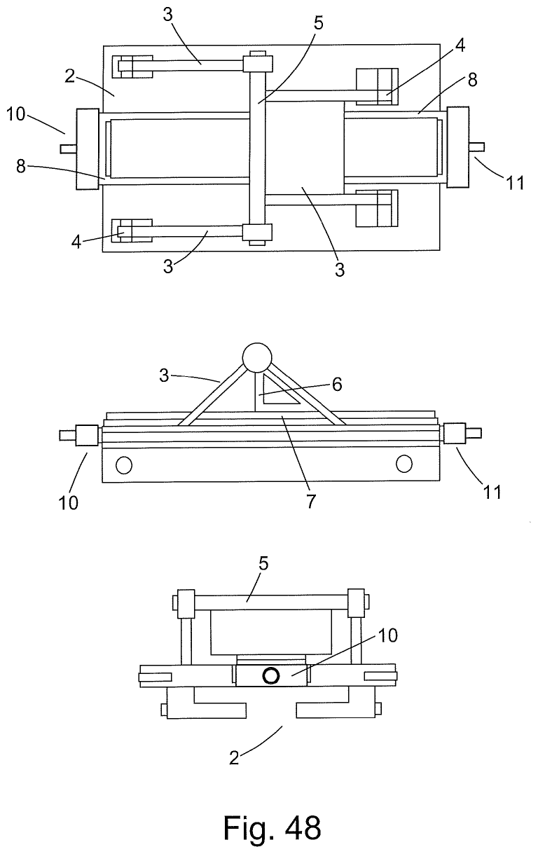

FIG. 48 shows a combined apex unit and sideplate units and pressure plate

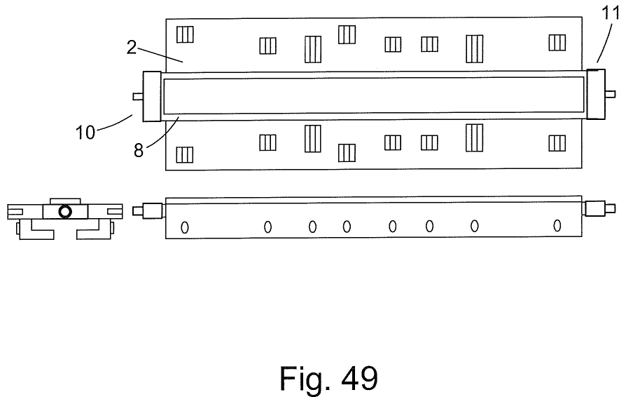

FIG. 49 shows the base for a multiple pump unit with installed tubular air space and additional semi flexible pressure plate

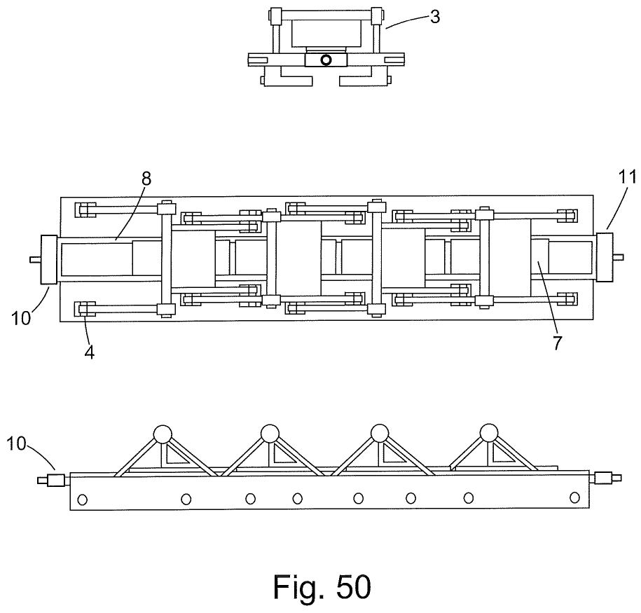

FIG. 50 shows a sequence of combined pump units with extended base plate and elongated tubular air space chamber in vacuum mode

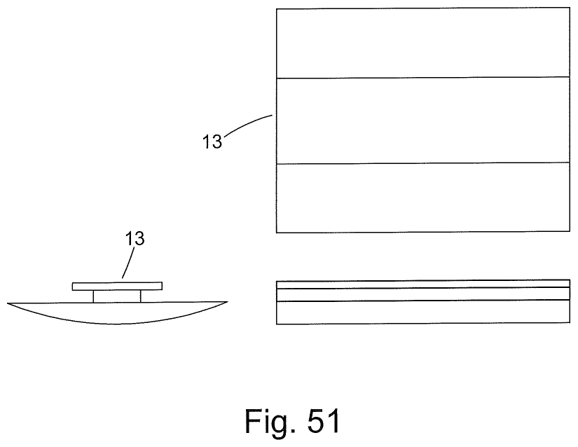

FIG. 51 shows a tread lock unit

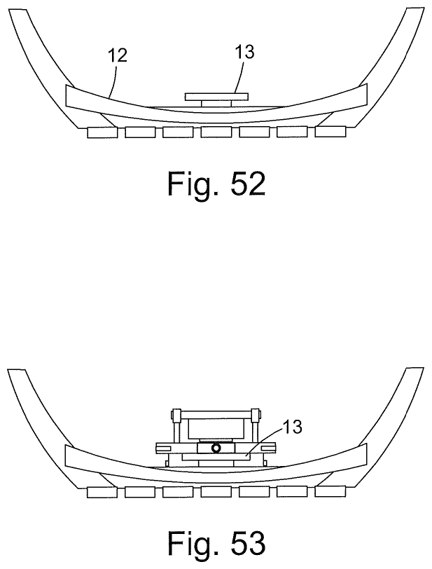

FIG. 52 shows the tread lock unit in place in the interior tread of the tyre

FIG. 53 shows the pump unit installed via the lock unit in the interior tread of the tyre

FIG. 54 shows in detail a pump unit in motion generating a peristaltic pressure wave upon a tubular air chamber

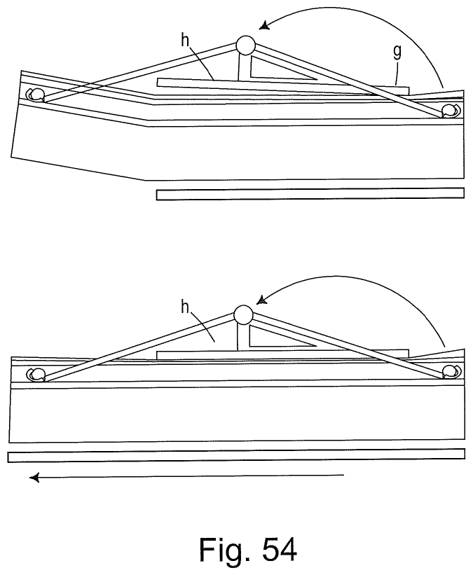

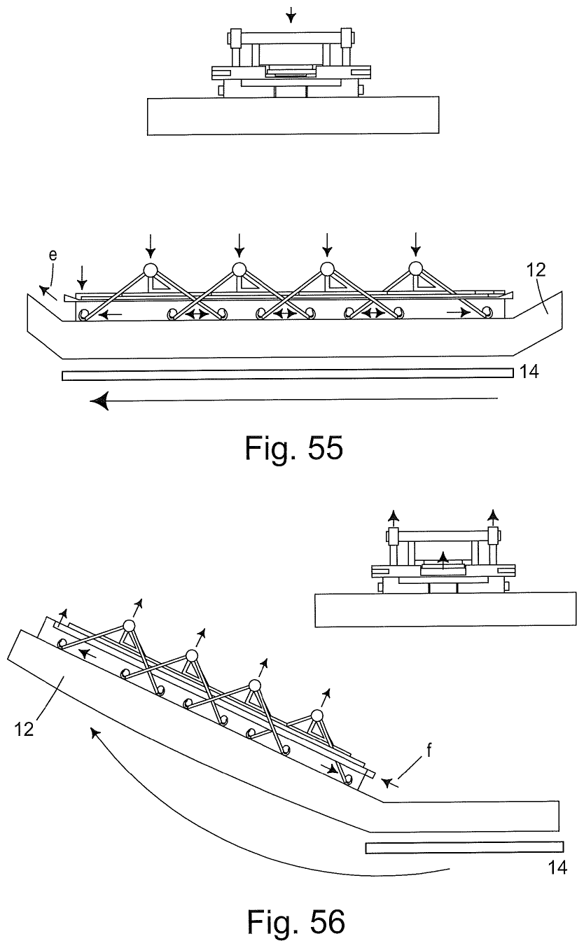

FIG. 55 shows a section of multiple pump units locked inside a revolving tyre tread and within the tyre patch operating sequentially to compress a tubular air chamber to generate a peristaltic pressure wave

FIG. 56 shows a section of multiple pump units locked inside a revolving tyre tread and exiting the tyre patch operating sequentially to release pressure on a tubular air chamber

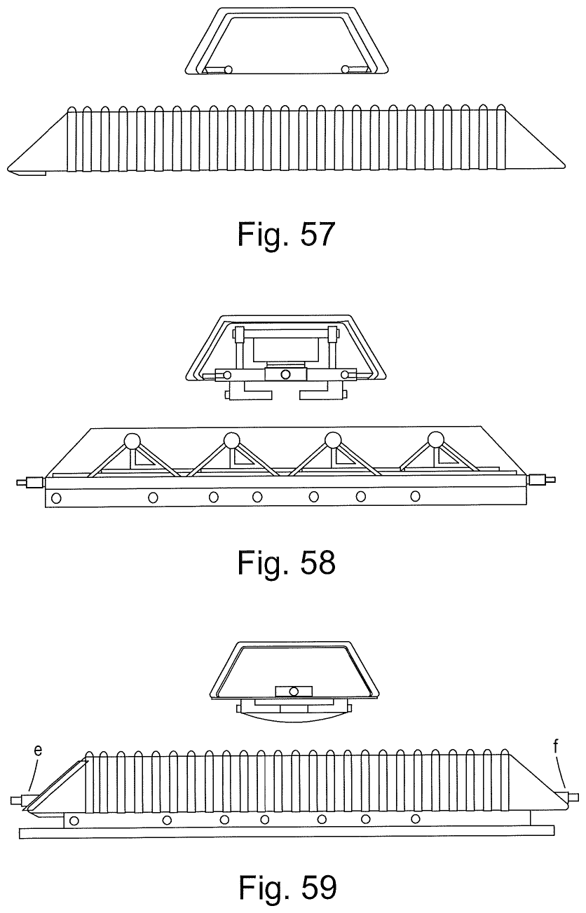

FIG. 57 shows a view of an armored pump unit cartridge in front and side view with pump unit installed

FIG. 58 shows a view of an armored pump unit cartridge in front and side view (semi transparent) with a sectioned pump unit installed

FIG. 59 shows a closed/sealed armored pump unit interlocked with a tread lock and with inlet and outlet valves

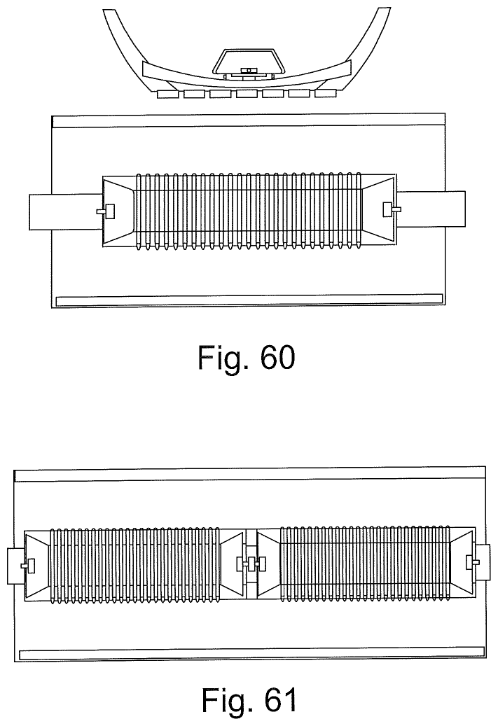

FIG. 60 shows a closed/sealed armored pump unit cartridge with inlet and outlet valves installed on the interior of a tyre tread via a tread lock in front and top view.

FIG. 61 shows a top view of two armored pump unit cartridges in sequence array.

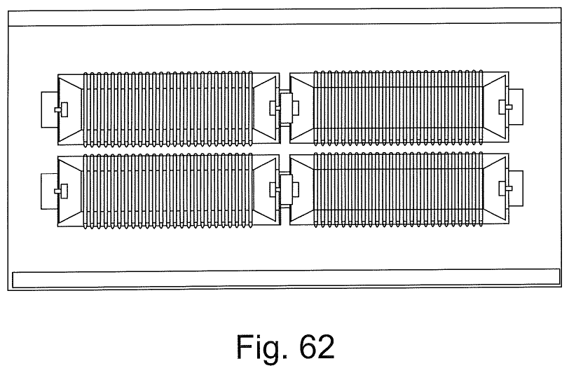

FIG. 62 shows a top view of two armored pump unit cartridges in sequence and in parallel array

Referring now to FIGS. 33 to 62, an inflated tyre has a contact patch (FIG. 33 (FIG. 33)) which is distributed around the circumference (FIG. 34) and deforms on contact with the ground to a prescribed degree (FIG. 35) A triangular structure anchored to a curved base (FIG. 35) is shown to lower when the base is flattened

(FIG. 35-a) and rise when the base is curved (FIG. 35-b) and when the curve is flattened incrementally (FIG. 36) that the base will lower incrementally first with the rear edge (FIG. 36-c) and lastly with the front edge (FIG. 36-d)

In the illustrations herein presented the pump has three iterations: In a first iteration:

A pump unit (FIG. 37)
has a flexible base unit (FIG. 37-2)
and twin sideplates (FIG. 37-3)
with clamp units secured to the shaped base plate (FIG. 37b-4)
and an apex unit (FIG. 37-5)
with pump arm (FIG. 37-6)
with pressure plate (FIG. 37-7)
together with a closed air space chamber (FIG. 37-8)
with membrane pump mechanism (FIG. 37-9)
having an inlet valve (FIG. 37-10)
connected to a fresh-air inlet valve (FIG. 43-15) via an air channel (FIG. 43-16)
and an outlet valve (FIG. 37-11)
such pump unit being connected to a tyre interior (FIG. 37-12)
via two intermediate tread lock units (FIG. 37-13)

Such arrangement having the effect that when the pump unit (FIG. 38-13) passes through the patch area (FIG. 38-14) of a revolving tyre (FIG. 38-12) The pump is activated (pump mode) to compress and expel air (FIG. 39) And when the pump unit passes out of the patch area of a revolving tyre (FIG. 40) the pump is activated (vacuum mode) to take air in (FIG. 40-e).

In a second iteration:
A pump unit (FIG. 41)
has a flexible shaped base plate (FIG. 41-2)
Twin sideplates (FIG. 41-3)
With clamp units (FIG. 41-4) secured to the shaped base plate
And an apex unit (FIG. 41-5)
With pump arm (FIG. 41-6)
With pressure plate (FIG. 41-7)
together with a closed air space chamber (FIG. 41-8)
with bellows pump mechanism (FIG. 41-9)
having an inlet valve (FIG. 41-10)
connected to a fresh-air inlet valve (FIG. 43-15) via an air channel (FIG. 43-16)
and an outlet valve (FIG. 41-11)
such pump unit being connected to a tyre interior (12-12)
via an intermediate tread lock unit (FIG. 42-13)
Such arrangement having the effect that when the pump unit passes
through the patch area of a revolving tyre (FIG. 46-12)
The pump is activated (pump mode) to compress and expel air (FIG. 46-e)
And when the pump unit passes out of the patch area of a revolving tyre (FIG. 47-12) the pump is activated (vacuum mode) to take air in (FIG. 47-f)

In a third iteration:
A pump unit (FIG. 48)
has a flexible shaped base plate (FIG. 48-2)
and twin sideplates (FIG. 48-3)
With clamp units (FIG. 48-4)
And an apex unit (FIG. 48-5)
With pump arm (FIG. 48-6)
With pressure plate (FIG. 48-7)
together with a closed tubular air space chamber (FIG. 48-8)
with peristaltic pump assistance second pressure plate (FIG. 48-9)
having an inlet valve (FIG. 48-10)
connected to a fresh-air inlet valve (FIG. 43-15) via an air channel (FIG. 43-16)
and an outlet valve (FIG. 48-11)
such pump unit being connected to a tyre interior (FIG. 53-12)
via an intermediate tread lock unit (FIG. 51)/(FIG. 52-13)

Such arrangement when multiple pumps are aligned (FIG. 50) having the effect that when the pump units pass through the patch area of a revolving tyre (FIG. 55-14) the pump is activated (pump mode) to compress and expel air (FIG. 55-e) And when the pump unit passes out of the patch area of a revolving tyre (FIG. 56-14) the pump is activated (vacuum mode) to take air in (FIG. 56-f)

Such arrangement further with multiple aligned pump units having the effect that the pump pressure plates exert pressure (FIG. 54-g) progressively and sequentially compress a tubular air chamber or space in peristaltic manner (FIG. 54-h).

By way of example applicable to all other iterations—the pump unit is shown encased in an armored cartridge (FIG. 57)/(FIG. 58)/(FIG. 59) via which the internal air chamber is provided with an inlet valve (FIG. 59-e) and an outlet valve (FIG. 59-f) Such cartridge being securely anchorable or locked to the inner tread of a vehicle tyre in multiple configurations (FIG. 60)/(FIG. 61)/(FIG. 62)

In Use—Single Pump

A pump unit (FIG. 37)/(FIG. 41)/(FIG. 48) is attached to the interior tread of a tyre (FIG. 38) (FIG. 45c) via a tread anchor (FIG. 37-13)/or tread lock unit (FIG. 42)/(FIGS. 44-13). An air inlet valve (FIG. 37-10)/(FIG. 41-10) is connected to the tyre exterior Via a fresh-air inlet valve (FIG. 43-15) via an air channel (FIG. 43-16). When the pump enters the patch area of a revolving tyre (FIG. 38-14)/(FIG. 46-14) the pump air chamber (FIG. 37-8)/(FIG. 41-8) is compressed and pumps air into the tyre via an outlet valve (FIG. 38-e)/(FIG. 46-e). When the pump exits the patch area (FIG. 40-14)/(FIG. 47-14) the pump air chamber (FIG. 37-8)/(FIGURE 41-8) expands thereby drawing air into the pump air chamber (FIG. 40-f)/(FIG. 47-f).

In Use—Multiple Pumps (Peristaltic)

A pump unit (FIG. 48) with shaped base unit (FIG. 48-2) And tubular air space chamber (FIG. 48-8) Is replicated with an extended base and multiple units (FIG. 50) and attached to the interior tread of a tyre (FIG. 53) via a tread lock unit (FIG. 51)/(FIG. 52-13)/(FIG. 53-13) An air inlet valve (FIG. 50-10) is connected to a fresh-air inlet valve (FIG. 43-15) via an air channel (FIG. 43-16) When the pump or section of the pump enters the patch area of a revolving tyre (FIG. 55-14) the pump tubular air space chamber (FIG. 48-8)/(FIGS. 50-8) is sequentially compressed and pushes air along the tube air chamber (FIG. 55-e) and into the tyre via an outlet valve (FIG. 50-11) when the pump exits the patch area (FIG. 56-14) the tubular air chamber (FIG. 48-8)/(FIG. 50-8) expands drawing air into tube chamber (FIG. 56-f) via an inlet valve (FIGS. 50-10) connected to a fresh-air inlet valve (FIG. 43-15) via an air channel (FIG. 43-16).

Before installation within a tyre the pump is placed inside an armored cartridge (FIG. 58). After installation in the tyre (FIG. 60) the cartridge may be replicated in convenient arrays (FIG. 61)/(FIG. 62)

The present invention has been described above purely by way of example. Modifications in detail may be made to the present invention within the scope of the claims as appended hereto.

Further according to an example is a tyre self inflation system in the form of a single pump unit or set of connected pump units installed in and securely affixed to the interior tread of a vehicle tyre either by way of discrete anchors in the tread of the tyre or by way of vulcanisation or by way of interlocking with an intermediate anchor plate or other such secure methods in any combination thereof each pump unit or set of pump units having a compressible air chamber with at least one regulated air channel connected to the tyre exterior and at least one regulated air channel connected to the tyre interior together with a single or connected sequential pump mechanism which employs the deformation of the tyre tread in the area of the tyre patch when the tyre is rolling and weighted to compress and decompress a single air chamber or series of air chambers or sequential sections of an elongated air chamber and thereby pump air into the interior body of the tyre by way of single pump action or by way of a series of pump actions or by way of a combined and substantially peristaltic or quasi peristaltic action.

The activation or deactivation of the pump unit or units may be controlled in part or in full by reference to the PSI pressure within the tyre and or an alteration in the deformation of the tyre tread patch in accordance with such PSI pressure and such control being either automatic or by the direction of an operator or by combination of the two including remote control by way of an electronic or digital or wireless or mechanical means or any combination thereof.

A pump unit or connected set of pump units may be protected and enclosed by a flexible or semi flexible casing structured to withstand exterior pressure and optionally internally pressurised.

The protective casing may be designed in substantially cartridge form and combinable with other such cartridges in variable configurations either as a series of discrete pump units or as a combined multi pump unit and such cartridge form being further designed so as to be conveniently connectable to the tyre by way of an intermediate tread lock plate or connection unit vulcanised or anchored or otherwise securely preinstalled in the interior tyre tread.

Air compressed by the system may be directed into the tyre via an intermediate storage or holding vessel within the tyre body such vessel being structured to hold compressed air at a pressure above that of the recommended PSI of the tyre and such vessel having the capacity to vent stored air into the tyre when required.

In all examples according to the disclosure: the upper and lower sides of the compressible chamber may be attached to or form part of the surface means by which the chamber is compressed and decompressed; the compression plate may be rigid or substantially rigid; the restraints may be either adjustable or fixed or any combination thereof; and/or the compressible chamber may be protected from in-tyre pressure by a protective enclosure.

1. A pump for use on the inside surface of the tread of a tyre, the pump comprising:
a base plate for attaching to the inside surface of the tread of a tyre;
a compression plate;
a first restraint connected to the base plate and arranged to engage a first side of the compression plate;
a second restraint connected to the base plate and arranged to engage a second side of the compression plate; and
a compressible chamber arranged between the compression plate and the base plate;
wherein the compressible chamber comprises an inlet and an outlet and is arranged to contain a fluid;
wherein the pump is arranged such that when the pump is attached to the inside surface of the tread of a rolling tyre, the first and second restraints move the compression plate relative to the base plate as the pump traverses a contact patch of the tyre such that the compressible chamber is peristaltically compressed between the compression plate and the base plate, ejecting fluid from the compressible chamber through the outlet and then drawing fluid in to the compressible chamber through the inlet; the pump further comprising:
a filtration device fluidically connectable to the environment for receiving fluid from the environment;
wherein the pump is configured to expel fluid through the filtration device to clean the filtration device.

2. A pump according to claim 1, wherein the pump is configured such that fluid can be expelled from the compressible chamber, through the filtration device, which is a valve, into the environment for cleaning the filtration device.

3. A pump according to claim 1, wherein fluidic communication between the environment and the pump is regulated by the filtration device; the filtration device is configured to reduce the ingress of dirt into the apparatus; and the filtration device is cleanable by fluid expelled into the environment via the filtration device, powered by the operation of the pump.

4. A pump according to claim 1, wherein the filtration device is connected to the inlet of the compressible chamber.

5. A pump according to claim 4, wherein the filtration device is additionally connected to the outlet of the compressible chamber; such that air can be received into the compressible chamber from the filtration device and expelled from the compressible chamber through the filtration device.

6. (canceled)

7. (canceled)

8. A pump according to claim 1, wherein the inlet of the compressible chamber is fluidically connectable to the environment; and
the outlet of the compressible chamber is fluidically connectable to the inside of a tyre.

9. A pump according to claim 1, wherein each restraint is adjustable in length.

10.-12. (canceled)

13. A pump according to claim 1, wherein the first and second restraints are rigid and are connected to the compression plate such that they are arranged to move the compression plate away from the base plate when the curvature of the base plate increases.

14. A pump according to claim 1, further comprising a surrounding wall arranged around the compressible chamber.

15. A pump according to claim 14, wherein the surrounding wall is resiliently deformable and is arranged to bias the compression plate away from the compressible chamber.

16. A pump according to claim 14, wherein the surrounding wall comprises a wall-valve configured to allow air into the surrounding wall from the tyre and the surrounding wall is configured to comprise pressurised fluid.

17. (canceled)

18. A pump according to claim 1, further comprising a support arranged between the base plate and the compressible chamber, the support comprising guides arranged to engage guides on the base plate; and a flat upper surface arranged to support the compressible chamber.

19. A pump according to claim 1, further comprising an output valve fluidically connected to the compressible chamber outlet and for outputting fluid into a tyre, wherein the pump is configured such that when the pump is attached to the inside surface of the tread of a rolling tyre, fluid is only ejected through the output valve when the tyre pressure drops below a threshold pressure value.

20. A pump according to claim 1, further comprising a fluid reservoir located between and fluidically connected to the outlet of the compressible chamber and the output valve.

21. (canceled)

22. (canceled)

23. A pump according to claim 20, wherein
the output valve is a one-way valve arranged to prevent fluid flowing from a tyre into the pump;
the fluid reservoir is arranged to receive fluid ejected from the compressible chamber and output fluid through the output valve when the pressure in the reservoir is greater than the pressure in the tyre;
the relative volumes of the compressible chamber and the fluid reservoir are selected such that the pressure of fluid in the fluid reservoir reaches the threshold value when the compressible chamber is fully compressed.

24. (canceled)

25. (canceled)

26. A pump according to claim 1, wherein the pump is configured such that fluid is restricted from passing from the compressible chamber out of the inlet as the compression plate moves towards the base plate; and fluid can move through the compressible chamber and out of the inlet as the compression plate moves away from the base plate.

27. A pump according to claim 26, wherein the pump comprises a compression surface against which the compressible chamber is compressed by the compression plate; wherein one of the compression surface and the compression plate comprises a protrusion adjacent the inlet of the compressible chamber and the other of the compression surface and the compression plate comprises a complementary recess arranged to mate with the protrusion; wherein the pump is configured such that, during use, the protrusion and recess mate as soon as the compression plate moves towards the base plate, thus restricting fluid from passing from the compressible chamber out of the inlet; and the protrusion and recess disengage as soon as the compression plate starts to move away from the base plate.

28.-30. (canceled)

31. A pump apparatus comprising a plurality of pumps according to claim 1 connected in series, wherein
the outlet of the compressible chamber of a first pump is connected to an inlet of the compressible chamber of a second pump; and
the pump apparatus is arranged to peristaltically pump fluid through the plurality of pumps.

32. A pump apparatus according to claim 31, wherein
the pump apparatus comprises a single compressible fluid container arranged to form the compressible chambers of each of the pumps; and/or
the pump apparatus comprises a single elongated base plate arranged to form the base plates of each of the pumps.

33. A tyre apparatus comprising:
a tyre;
a first pump according to claim 1, attached to the inside surface of the tread of the tyre; and
a second pump according to claim 1, attached to the inside surface of the tread of the tyre; wherein
the tyre comprises a filtration device for allowing fluidic communication between the first pump and the environment, and the second pump and the environment;
the inlet of the compressible chamber of the first pump is connected to the filtration device for receiving fluid from the environment; and
the outlet of the compressible chamber of the first pump is arranged to output fluid to the inside of the tyre; and
the inlet of the compressible chamber of the second pump is connected to the filtration device for receiving fluid from the environment; and
the outlet of the compressible chamber of the second pump is connected to the filtration device for expelling fluid through the filtration device.

34.-40. (canceled)
